(19) United States
(12) Patent Application Publication
(10) Pub. No.: US 2010/0099018 A1
(43) Pub. Date: Apr. 22, 2010

(54) SECONDARY BATTERY

(75) Inventors: Kenichi Kawase, Fukushima (JP); Tomoo Takada, Fukushima (JP); Kazunori Noguchi, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/578,980

(22) Filed: Oct. 14, 2009

(30) Foreign Application Priority Data
Oct. 15, 2008 (JP) P2008-266257

(51) Int. Cl. H01M 10/0567

(52) U.S. Cl. 429/105

(57) ABSTRACT

A secondary battery capable of improving cycle characteristics, initial charge and discharge characteristics, and swollenness characteristics is provided. The secondary battery includes a cathode, an anode, and an electrolytic solution. The electrolytic solution is impregnated in a separator provided between the cathode and the anode. A cathode active material layer of the cathode contains a lithium-nickel based composite oxide (LiNi1-xMxO2) as a cathode active material capable of inserting and extracting lithium ions. An anode active material layer of the anode contains a material having silicon as an element as an anode active material capable of inserting and extracting lithium ions. The usage ratio in the fully charged state of the anode is set from 20% to 70% both inclusive, and the thickness in discharged state in the initial charge and discharge of the anode active material layer is 40 μm or less

### CROSS REFERENCES TO RELATED APPLICATIONS

The present application claims priority to Japanese Priority Patent Application JP 2008-266257 filed in the Japanese Patent Office on Oct. 15, 2008, the entire contents of which is hereby incorporated by reference.

### BACKGROUND

The present application relates to a secondary battery that includes an electrolyte together with a cathode and an anode capable of inserting and extracting an electrode reactant.

In recent years, portable electronic devices such as a video camera, a digital still camera, a mobile phone, and a notebook personal computer have been widely used, and it is strongly demanded to reduce their size and weight and to achieve their long life. Accordingly, as an electric power source for the portable electronic devices, a battery, in particular a small and light-weight secondary battery capable of providing a high energy density has been developed.

Specially, a lithium ion secondary battery using insertion and extraction of lithium ions for charge and discharge reaction is in practical use widely, since such a lithium ion secondary battery is able to provide a higher energy density than a lead battery and a nickel cadmium battery.

The lithium ion secondary battery includes a cathode containing a cathode active material capable of inserting and extracting lithium ions, an anode containing an anode active material capable of inserting and extracting lithium ions, and an electrolyte.

As the cathode active material, a composite oxide having lithium and a transition metal element as an element is widely used. Specially, a lithium-nickel based composite oxide that has one or more transition metal elements (excluding nickel) together with lithium and nickel attracts attentions, since such as lithium-nickel based composite oxide is able to stably provide a high battery capacity. The lithium-nickel based composite oxide is obtained by substituting part of nickel out of lithium nickel composite oxide (LiNiO₂) with one or more transition metal elements.

Meanwhile, as the anode active material, a carbon material such as graphite is widely used. However, in recent years, as the high performance and the multi functions of the portable electronic devices are developed, further improving the battery capacity is demanded. Thus, a high capacity material having silicon as a main component attracts attentions. Since the theoretical capacity of silicon (4199 mAh/g) is significantly higher than the theoretical capacity of graphite (372 mAh/g), it is prospected that the battery capacity is thereby highly improved.

However, in the case where the high capacity material is used as an anode active material, the anode active material inserting lithium ions in charge and discharge becomes highly active. Thus, the electrolyte is easily decomposed, and part of the lithium ions easily becomes inactive. Thereby, the discharge capacity is easily lowered, and thus sufficient cycle characteristics and sufficient initial charge and discharge characteristics are hardly obtained. Further, since gas is generated in the battery due to decomposition of the electrolyte, swollenness characteristics tend to be easily lowered.

Therefore, in order to improve the various characteristics such as the cycle characteristics, various devices have been exercised. Specifically, lithium ions with a portion from 0.5% to 40% both inclusive of the anode capacity are previously inserted in the anode active material (for example, refer to Japanese Unexamined Patent Application Publication No. 2005-085633). Further, the molar ratio of lithium atom to silicon atom in the anode (Li/Si) is set to 0.4 or more (for example, refer to Japanese Unexamined Patent Application Publication No. 2005-235734). Further, the usage ratio in a fully charged state of the anode is set to from 35% to 85% both inclusive (for example, refer to Japanese Unexamined Patent Application Publication No. 2007-027008).

### SUMMARY

In these years, the high performance and the multi functions of the portable electronic devices are increasingly developed, and the electric power consumption thereof tends to be increased. Accordingly, charge and discharge of the secondary battery tend to be frequently repeated. Accordingly, in order to use the secondary battery frequently and safely, further improvement of the cycle characteristics, the initial charge and discharge characteristics, and the swollenness characteristics has been aspired.

It is desirable to provide a secondary battery capable of improving the cycle characteristics, the initial charge and discharge characteristics, and the swollenness characteristics.

According to an embodiment, there is a provided a secondary battery including a cathode having a cathode active material layer on a cathode current collector, an anode having an anode active material layer on an anode current collector, and an electrolyte containing a solvent and an electrolyte salt. The cathode active material layer contains a cathode active material being capable of inserting and extracting an electrode reactant and being expressed by Formula 1. The anode active material layer contains an anode active material being capable of inserting and extracting the electrode reactant and having silicon as an element. A usage ratio in a fully charged state of the anode is from 20% to 70% both inclusive. A thickness of the anode active material layer in a discharged state in an initial charge and discharge is 40 μm or less.

Formula 1

LiNi₁₋ₓMₓO₂ (1)

In the formula, M is one or more of cobalt, manganese, iron, aluminum, vanadium, tin, magnesium, titanium, strontium, calcium, zirconium, molybdenum, technetium, ruthenium, tantalum, tungsten, rhenium, ytterbium, copper, zinc, barium, boron, chromium, silicon, gallium, phosphorus, antimony, and niobium x is in the range of 0.005<x<0.5.

The usage ratio Z (%) in the fully charged state of the anode is expressed by Z=(X/Y)*100. In the formula, X represents an insertion amount of the electrode reactant per unit area in the fully charged state of the anode, and Y represents an electrode reactant amount capable of being electrochemically inserted into the anode per unit area.

“In the initial charge and discharge” means a charged and discharged state of the secondary battery that is not in a state that the battery performance is extremely deteriorated due to excessive repetition of charge and discharge. Specifically, “in the initial charge and discharge” means a state that the number of charge and discharge cycles is 50 or less after the secondary battery is manufactured (the secondary battery has not been charged and discharged yet). Otherwise, “in the initial charge and discharge” means a state that a ratio between the discharge capacity obtained in charging and discharging 1 cycle and the discharge capacity obtained in subsequently charging and discharging 1 cycle (discharge capacity retention ratio (%)=(discharge capacity of the latter/discharge capacity of the former)*100) is 95% or more. The thickness of the anode active material layer in this case is a thickness on a single face side of the anode current collector.

The secondary battery according to an embodiment satisfy the following four conditions A to D:

A. The cathode active material layer of the cathode contains the cathode active material being capable of inserting and extracting the electrode reactant and being expressed by Formula 1.

B. The anode active material layer of the anode contains the anode active material being capable of inserting and extracting the electrode reactant and having silicon as an element.

C. The usage ratio in a fully charged state of the anode is from 20% to 70% both inclusive.

D. The thickness of the anode active material layer in a discharged state in the initial charge and discharge is 40 μm or less.

Thereby, while a high energy density is secured, in charge and discharge, decomposition of the electrolyte and dropping or the like of the anode active material layer are inhibited. Therefore, the cycle characteristics, the initial charge and discharge characteristics, and the swollenness characteristics are able to be improved.

Additional features and advantages are described herein, and will be apparent from the following Detailed Description and the figures.

### BRIEF DESCRIPTION OF THE FIGURES

FIG. 1 is a cross sectional view illustrating a structure of a secondary battery according to a first embodiment;

FIG. 2 is a cross sectional view illustrating a structure taken along line II-II of the secondary battery illustrated in FIG. 1;

FIGS. 3A and 3B are an SEM photograph illustrating a cross sectional structure of the anode illustrated in FIG. 1 and a schematic drawing thereof, respectively;

FIGS. 4A and 4B are an SEM photograph illustrating another cross sectional structure of the anode illustrated in FIG. 1 and a schematic drawing thereof, respectively;

FIG. 5 is a cross sectional view illustrating a structure of a secondary battery according to a second embodiment;

FIG. 6 is a cross sectional view illustrating an enlarged part of the spirally wound electrode body illustrated in FIG. 5;

FIG. 7 is an exploded perspective view illustrating a structure of a secondary battery according to a third embodiment;

FIG. 8 is a cross sectional view illustrating a structure taken along line VIII-VIII of the spirally wound electrode body illustrated in FIG. 7;

FIG. 9 is a diagram illustrating a relation between a usage ratio and a discharge capacity retention ratio/an initial discharge efficiency (cathode active material: LiNi_{0.80}Co_{0.20}O₂);

FIG. 10 is a diagram illustrating a relation between a usage ratio and a discharge capacity retention ratio/an initial discharge efficiency (cathode active material: LiNi_{0.80}Co_{0.14}Mn_{0.10}O₂);

FIG. 11 is a diagram illustrating a relation between a usage ratio and a discharge capacity retention ratio/an initial discharge efficiency (cathode active material: LiNi_{0.79}Co_{0.14}Al_{0.07}O₂);

FIG. 12 is a diagram illustrating a relation between a usage ratio and a discharge capacity retention ratio/an initial discharge efficiency (cathode active material: LiNi_{0.76}Co_{0.20}Al_{0.06}Ba_{0.01}O₂);

FIG. 13 is a diagram illustrating a relation between a usage ratio and a discharge capacity retention ratio/an initial discharge efficiency (cathode active material: LiNi_{0.08}Co_{0.10}Al_{0.06}Fe_{0.04}O₂);

FIG. 14 is a diagram illustrating a relation between a usage ratio and a discharge capacity retention ratio/an initial discharge efficiency (cathode active material: LiNiO₂);

FIG. 15 is a diagram illustrating a relation between a usage ratio and a discharge capacity retention ratio/an initial discharge efficiency (cathode active material: LiCoO₂);

FIG. 16 is a diagram illustrating a relation between a usage ratio and a discharge capacity retention ratio/an initial discharge efficiency (cathode active material: LiMn₂O₂);

FIG. 17 is a diagram illustrating a relation between an initial charge and discharge thickness and a discharge capacity retention ratio (anode active material: Si (evaporation method));

FIG. 18 is a diagram illustrating a relation between an initial charge and discharge thickness and a discharge capacity retention ratio (anode active material: Si (spraying method));

FIG. 19 is a diagram illustrating a relation between an upper voltage and a discharge capacity retention ratio (anode usage ratio: 40%);

FIG. 20 is a diagram illustrating a relation between an upper voltage and a discharge capacity retention ratio (anode usage ratio: 60%);

FIG. 21 is a diagram illustrating a relation between a cutoff voltage and a discharge capacity retention ratio (anode usage ratio: 40%); and

FIG. 22 is a diagram illustrating a relation between a cutoff voltage and a discharge capacity retention ratio (anode usage ratio: 60%).

### DETAILED DESCRIPTION

Embodiments will be hereinafter described in detail with reference to the drawings.

### First Embodiment

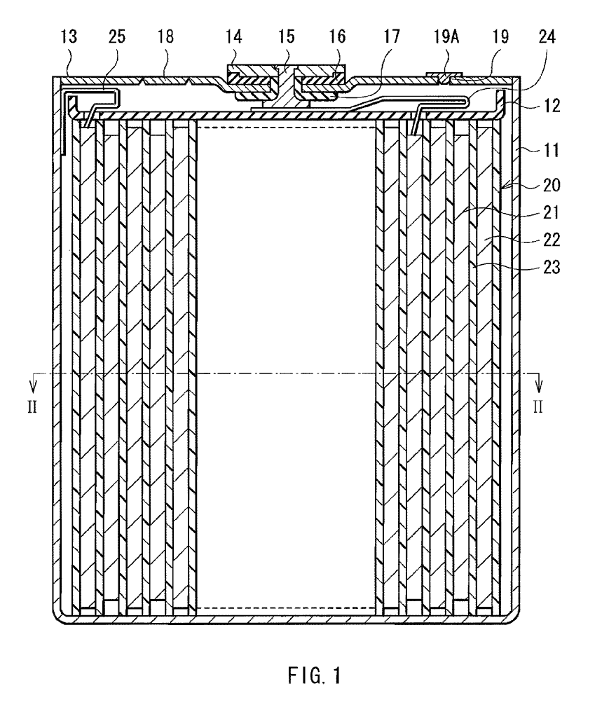

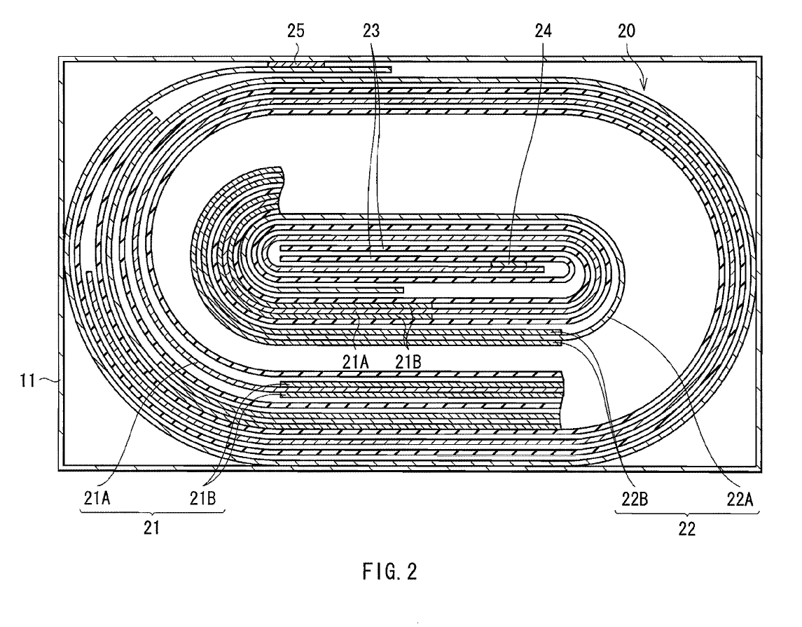

FIG. 1 and FIG. 2 illustrate cross sectional structures of a secondary battery according to a first embodiment of the invention. FIG. 2 illustrates a cross section taken along line II-II illustrated in FIG. 1.

The secondary battery is, for example, a lithium ion secondary battery in which the capacity of an anode is expressed based on insertion and extraction of lithium ions as an electrode reactant. In the secondary battery, a battery element 20 having a spirally wound structure is contained in a battery can 11 mainly.

The battery can 11 is, for example, a square package member. As illustrated in FIG. 2, the square package member has a shape with the cross section in the longitudinal direction of a rectangle or an approximate rectangle (including curved lines in part). The square package member structures not only a square battery in the shape of a rectangle, but also a square battery in the shape of an oval. That is, the square package member means a rectangle vessel-like member with the bottom or an oval vessel-like member with the bottom, which respectively has an opening in the shape of a rectangle or in the shape of an approximate rectangle (oval shape) formed by connecting circular arcs by straight lines. FIG. 2 illustrates a case that the battery can 11 has a rectangular cross sectional shape. The battery structure using the battery can 11 is called square structure.

The battery can 11 is made of, for example, iron, aluminum, an alloy thereof or the like. In some cases, the battery can 11 has a function as an electrode terminal. Specially, to inhibit the secondary battery from being swollen by using the rigidity (hardly deformable characteristics) of the battery can 11 in charge and discharge, rigid iron is more preferable than aluminum. In the case where the battery can 11 is made of iron, the battery can 11 may be plated by, for example, nickel or the like.

Further, the battery can 11 has a hollow structure in which one end of the battery can 11 is closed and the other end of the battery can 11 is opened. At the open end of the battery can 11, an insulating plate 12 and a battery cover 13 are attached, and thereby inside of the battery can 11 is hermetically closed. The insulating plate 12 is located between the battery element 20 and the battery cover 13, is arranged perpendicularly to the spirally wound circumferential face of the battery element 20, and is made of, for example, polypropylene or the like. The battery cover 13 is, for example, made of a material similar to that of the battery can 11, and may have a function as an electrode terminal as the battery can 11 does.

Outside of the battery cover 13, a terminal plate 14 as a cathode terminal is arranged. The terminal plate 14 is electrically insulated from the battery cover 13 with an insulating case 16 in between. The insulating case 16 is made of, for example, polybutylene terephthalate or the like. Further, in the approximate center of the battery cover 13, a through-hole is provided. A cathode pin 15 is inserted in the through-hole so that the cathode pin is electrically connected to the terminal plate 14 and is electrically insulated from the battery cover 13 with a gasket 17 in between. The gasket 17 is made of, for example, an insulating material, and the surface thereof is coated with asphalt.

In the vicinity of the rim of the battery cover 13, a splitting valve 18 and an injection hole 19 are provided. The splitting valve 18 is electrically connected to the battery cover 13. In the case where the internal pressure of the battery becomes a certain level or more by internal short circuit, external heating or the like, the splitting valve 18 is separated from the battery cover 13 to release the internal pressure. The injection hole 19 is sealed by a sealing member 19A made of, for example, a stainless corundum or the like.

The battery element 20 is formed by layering a cathode 21 and an anode 22 with a separator 23 in between and spirally winding the resultant laminated body. The battery element 20 is planular according to the shape of the battery can 11. A cathode lead 24 made of aluminum or the like is attached to an end of the cathode 21 (for example, the internal end thereof). An anode lead 25 made of nickel or the like is attached to an end of the anode 22 (for example, the outer end thereof). The cathode lead 24 is electrically connected to the terminal plate 14 by being welded to an end of the cathode pin 15. The anode lead 25 is welded and electrically connected to the battery can 11.

In the cathode 21, for example, a cathode active material layer 21B is provided on both faces of a cathode current collector 21A having a pair of faces. However, the cathode active material layer 21B may be provided only on a single face of the cathode current collector 21A.

The cathode current collector 21A is made of, for example, aluminum, nickel, stainless or the like.

The cathode active material layer 21B contains, as a cathode active material, one or more cathode materials capable of inserting and extracting lithium ions. According to needs, the cathode active material layer 21B may contain other material such as a cathode binder or a cathode electrical conductor.

As the cathode material capable of inserting and extracting lithium ions, one or more of composite oxides expressed by Formula 1 is preferable, since thereby a high battery capacity is able to be obtained stably. The composite oxide expressed by Formula 1 is a composite oxide having one or more transition metal elements (excluding nickel) as an element together with lithium and nickel (lithium-nickel based composite oxide).

Formula 1

LiNi₁₋ₓMₓO₂ (1)

In the formula, M is one or more of cobalt, manganese, iron, aluminum, vanadium, tin, magnesium, titanium, strontium, calcium, zirconium, molybdenum, technetium, ruthenium, tantalum, tungsten, rhenium, ytterbium, copper, zinc, barium, boron, chromium, silicon, gallium, phosphorus, antimony, and niobium. x is in the range of 0.005<x<0.5.

As M in Formula 1, one or more of cobalt, manganese, aluminum, barium, and iron is specially preferable. Examples of such a composite oxide include a lithium nickel cobalt composite oxide (LiNi₁₋ₓCoₓO₂), a lithium nickel cobalt manganese composite oxide (LiNi₁₋ₓ(CoMn)ₓO₂), a lithium nickel cobalt aluminum composite oxide (LiNi₁₋ₓ(CoAl)ₓO₂), a lithium nickel cobalt aluminum barium composite oxide (LiNi₁₋ₓ(CoAlBa)ₓO₂), and a lithium nickel cobalt aluminum iron composite oxide (LiNi₁₋ₓ(CoAlFe)ₓO₂). More specifically, examples thereof include lithium nickel cobalt composite oxide (LiNi_{0.80}Co_{0.20}O₂), lithium nickel cobalt manganese composite oxide (LiNi_{0.80}Co_{0.10}Mn_{0.10}O₂), lithium nickel cobalt aluminum composite oxide (LiNi_{0.79}Co_{0.14}Al_{0.70}O₂), lithium nickel cobalt aluminum barium composite oxide (LiNi_{0.76}Co_{0.20}Al_{0.03}Ba_{0.01}O₂), and lithium nickel cobalt aluminum iron composite oxide (LiNi_{0.80}Co_{0.10}Al_{0.06}Fe_{0.04}O₂). The chemical formulas in parentheses following the names of the foregoing composite oxides are described as an example of composition of each composite oxide. It is needless to say that the compositions of the composite oxides are not limited to the foregoing compositions.

The cathode active material layer 21B may contain other cathode material capable of inserting and extracting lithium ions, as long as the cathode active material layer 21B contains the foregoing lithium-nickel based composite oxide.

Examples of such other cathode materials include a composite oxide having lithium and a transition metal element as an element (excluding the lithium-nickel based composite oxide), and a phosphate compound having lithium and a transition metal element as an element. Specially, a compound containing one or more selected from the group made of nickel, cobalt, manganese, and iron as a transition metal element is preferable, since thereby a higher voltage is able to be obtained. The chemical formula thereof is expressed by, for example, LiₓMlO₂ or Li_{y}M2PO₄. In the formula, M1 and M2 represent one or more transition metal elements. Values of x and y vary according to the charge and discharge state, and are generally in the range of 0.05≦x≦1.10 and 0.05≦y≦1.10.

Examples of composite oxides containing lithium and a transition metal element include a lithium nickel composite oxide (LiₓNiO₂), a lithium cobalt composite oxide (LiₓCoO₂), and lithium manganese composite oxide having a spinel structure (LiMn₂O₄). Examples of phosphate compounds having lithium and a transition metal element include lithium iron phosphate compound (LiFePO₄) and a lithium iron manganese phosphate compound (LiFe₁₋ᵤMnᵤPO₄ (u<1)).

Further, examples of other cathode materials include an oxide such as titanium oxide, vanadium oxide, and manganese dioxide; a disulfide such as titanium disulfide and molybdenum sulfide; a chalcogenide such as niobium selenide; sulfur; and a conductive polymer such as polyaniline and polythiophene.

It is needless to say that the cathode material capable of inserting and extracting lithium ions may be a material other than the foregoing compounds. Further, two or more of cathode materials may be used by mixture voluntarily as long as the mixture contains the lithium-nickel based composite oxide.

Examples of cathode binders include a synthetic rubber such as styrene butadiene rubber, fluorinated rubber, and ethylene propylene diene; and a polymer material such as polyvinylidene fluoride. One thereof may be used singly, or a plurality thereof may be used by mixture.

Examples of cathode electrical conductors include a carbon material such as graphite, carbon black, acetylene black, Ketjen black, and Vapor Growth Carbon Fiber (VGCF). Such a carbon material may be used singly, or a plurality thereof may be used by mixture. The cathode electrical conductor may be a metal, a conductive polymer or the like as long as the material has the electric conductivity.

In the anode 22, for example, an anode active material layer 22B is provided on both faces of an anode current collector 22A having a pair of faces. However, the anode active material layer 22B may be provided only on a single face of the anode current collector 22A.

The anode current collector 22A is made of a material having a favorable electrochemical stability, a favorable electric conductivity, and a favorable mechanical strength. Examples of such a material include copper, nickel, titanium, and stainless.

The surface of the anode current collector 22A is preferably roughened. Thereby, due to the so-called anchor effect, the contact characteristics between the anode current collector 22A and the anode active material layer 22B are improved. In this case, it is enough that at least the surface of the anode current collector 22A opposed to the anode active material layer 22B is roughened. Examples of roughening methods include a method of forming fine particles by electrolytic treatment. The electrolytic treatment is a method of providing concavity and convexity by forming fine particles on the surface of the anode current collector 22A by using electrolytic method in an electrolytic bath. A copper foil formed by using the electrolytic method is generally called “electrolytic copper foil.” The surface roughness of the anode current collector 22A is able to be voluntarily set.

The anode active material layer 22B contains one or more anode materials capable of inserting and extracting lithium ions as an anode active material, and may also contain other material such as an anode binder or an anode electrical conductor according to needs. Details of the anode binder and the anode electrical conductor are, for example, respectively similar to those of the cathode binder and the cathode electrical conductor.

In the anode active material layer 22B, in order to prevent lithium ions from being precipitated unintentionally, the chargeable capacity in the anode material capable of inserting and extracting lithium ions is preferably larger than the discharge capacity of the cathode 21.

The anode active material layer 22B is formed by, for example, vapor-phase deposition method, liquid-phase deposition method, spraying method, coating method, firing method, or a combination of two or more of these methods. In this case, the anode current collector 22A and the anode active material layer 22B are preferably alloyed in at least part of the interface thereof. More specifically, at the interface thereof, the element of the anode current collector 22A may be diffused in the anode active material layer 22B; the element of the anode active material layer 22B may be diffused in the anode current collector 22A; or these elements may be diffused in each other. Thereby, destruction due to expansion and shrinkage of the anode active material layer 22B in charge and discharge is inhibited, and the electron conductivity between the anode current collector 22A and the anode active material layer 22B is improved.

Examples of vapor-phase deposition methods include physical deposition method or chemical deposition method. Specifically, examples thereof include vacuum evaporation method, sputtering method, ion plating method, laser ablation method, thermal CVD (Chemical Vapor Deposition) method, and plasma CVD method. As liquid-phase deposition method, a known technique such as electrolytic plating and electroless plating is able to be used. Firing method (sintering method) is, for example, a method in which after the anode current collector is coated by using coating method, heat treatment is provided at temperature higher than the melting point of the anode binder or the like. For firing method, a known technique such as atmosphere firing method, reactive tiring method, or hot press firing method is available.

As the anode material capable of inserting and extracting lithium ions, one or more of materials having silicon as an element is preferable, since such a material is able to provide a high energy density. Examples of such a material include a simple substance, an alloy, or a compound of silicon, and one or more phases thereof at least in part. Specially, the simple substance of silicon is preferable.

“Alloys” in the invention include an alloy having one or more metal elements and one or more metalloid elements, in addition to an alloy made of two or more metal elements. Further, “alloys” in the invention may have a nonmetallic element. The structure thereof includes a solid solution, a eutectic crystal (eutectic mixture), an intermetallic compound, and a structure in which two or more thereof coexist.

The simple substance of silicon having purity of 80% or more is preferably used, since thereby a high electric capacity is obtained, and superior cycle characteristics and superior initial charge and discharge characteristics are obtained.

Examples of alloys of silicon include an alloy containing one or more selected of tin, nickel, copper, iron, cobalt, manganese, zinc, indium (In), silver (Ag), titanium, germanium (Ge), bismuth (Bi), antimony (Sb), and chromium as a second element other than silicon.

Examples of compounds of silicon include a compound having oxygen or carbon (C). The compounds of silicon may have the foregoing second element.

Examples of alloys or compounds of silicon include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), SnO_{w} (0<w≦2), and LiSiO.

The anode active material layer 22B contains, as an anode active material, the material having silicon as an element. Thus, while a high energy density is obtained, the anode active material inserting and extracting lithium ions in charge and discharge is easily expanded and shrunk. In this case, as charge and discharge are repeated, the thickness of the anode active material layer 22B is easily increased. Accordingly, if the thickness is excessively increased, the anode active material layer 22B is easily broken, or is easily dropped from the anode current collector 22A. Therefore, in order to prevent dropping or the like of the anode active material layer 22B, the thickness thereof in discharged state in the initial charge and discharge is 40 μm or less. Thereby, influence resulting from expansion and shrinkage of the anode active material layer 22B in charge and discharge is inhibited. In result, even if the thickness thereof is increased, superior cycle characteristics, superior initial charge and discharge characteristics, and superior swollenness characteristics are obtained. Since the superior cycle characteristics and the like are able to be obtained even if the thickness of the anode active material layer 22B is increased, the thickness of the anode active material layer 22B is preferably, for example, 3 μm or more in order to take advantage thereof.

The foregoing “in the initial charge and discharge” means a charged and discharged state of the secondary battery that is not in a state that the battery performance is extremely deteriorated due to excessive repetition of charge and discharge. Specifically, “in the initial charge and discharge” means a state that the number of charge and discharge cycles is 50 or less after the secondary battery is manufactured (the secondary battery has not been charged and discharged yet). Otherwise, “in the initial charge and discharge” means a state that a ratio between the discharge capacity obtained in charging and discharging 1 cycle and the discharge capacity obtained in subsequently charging and discharging 1 cycle (discharge capacity retention ratio (%)=(discharge capacity of the latter/discharge capacity of the former)*100) is 95% or more. The thickness of the anode active material layer 22B in forming the same is a given thickness, as long as the thickness thereof in the discharged state in the initial charge and discharge becomes 40 μm or less.

The reason why “in the initial charge and discharge” is regarded as a reference is as follows. That is, the state that the number of charge and discharge cycles is 50 or less is a state that significant performance deterioration of the secondary battery resulting from expansion and shrinkage of the anode active material layer 22B has not been generated yet (is inhibited), in which the thickness of the anode active material layer 22B is obtained in a manner of favorable reproduction without depending on the individual difference between each secondary battery. Therefore, as an index to determine whether or not superior cycle characteristics, superior initial charge and discharge characteristics, and superior swollenness characteristics are obtained, attention is focused on the thickness of the anode active material layer 22B in the discharged state in the initial charge and discharge.

“Thickness of the anode active material layer” in this case is a thickness on a single face side of the anode current collector. That is, in the case where the anode active material layer 22B is provided only on a single face of the anode current collector 22A, “thickness of the anode active material layer” means the thickness of the anode active material layer 22B. Meanwhile, in the case where the anode active material layer 22B is provided on both faces of the anode current collector 22A, “thickness of the anode active material layer” does not mean the total thickness of the anode active material layer 22B on both faces of the anode current collector 22A, but means a thickness of the anode active material layer 22B on each single face of the anode current collector 22A.

In particular, the anode active material preferably has oxygen as an element, since thereby expansion and shrinkage of the anode active material layer 22B are inhibited in charge and discharge. In this case, at least part of oxygen is preferably bonded with part of silicon. The bonding state may be in the form of silicon monoxide, silicon dioxide, or in the form of other metastable state. The oxygen content in the anode active material is not particularly limited. However, in the case where the oxygen content in the anode active material is calculated, a coat formed by decomposition of the electrolyte or the like is not included in the anode active material. That is, in the case where the oxygen content in the anode active material is calculated, oxygen in the foregoing coat is not included in the calculation.

The anode active material layer 22B in which the anode active material has oxygen as an element is formed by continuously introducing oxygen gas into a chamber in the case where the anode material is deposited by, for example, vapor-phase deposition method. In particular, in the case where a desired oxygen content is not obtained only by introducing the oxygen gas, a liquid (for example, moisture vapor or the like) may be introduced into the chamber as a supply source of oxygen.

Further, t is preferable that the anode active material layer 22B includes a high oxygen-containing region having a relatively high oxygen content and a low oxygen-containing region having a relatively low oxygen content in the layer (in the thickness direction), since expansion and shrinkage of the anode active material layer 22B are inhibited in charge and discharge.

In this case, in order to further inhibit expansion and shrinkage of the anode active material layer 22B, it is preferable that the high oxygen-containing region is sandwiched by the low oxygen-containing regions. It is more preferable that that the low oxygen-containing region and the high oxygen-containing region are alternately and repeatedly layered. Thereby, higher effects are able to be obtained.

The anode active material layer 22B having the high oxygen-containing region and the low oxygen-containing region is formed by, for example, intermittently introducing oxygen gas into a chamber or changing the oxygen gas amount introduced into the chamber in depositing the anode material by, for example, vapor-phase deposition method. It is needless to say that in the case where a desired oxygen content is not able to be obtained only by introducing the oxygen gas, liquid (for example, moisture vapor or the like) may be introduced into the chamber.

It is possible that the oxygen content of the high oxygen-containing region is clearly different from the oxygen content of the low oxygen-containing region, or the oxygen content of the high oxygen-containing region is not clearly different from the oxygen content of the low oxygen-containing region. In particular, in the case where the introduction amount of the foregoing oxygen gas is continuously changed, the oxygen content may be continuously changed. In the case where the introduction amount of the oxygen gas is intermittently changed, the high oxygen-containing region and the low oxygen-containing region become so-called “layers.” Meanwhile, in the case where the introduction amount of the oxygen gas is continuously changed, the high oxygen-containing region and the low oxygen-containing region become “lamellar state” rather than “layers.” In the latter case, it is preferable that the oxygen content is incrementally or continuously changed between the high oxygen-containing region and the low oxygen-containing region. If the oxygen content is changed drastically, there is a possibility that the ion diffusion characteristics are lowered, or the resistance is increased.

The anode active materiel contained in the anode active material layer 22B is preferably in a state of a plurality of particles that are arranged on the anode current collector 22A and are linked to the surface thereof. In this case, the anode active material layer 22B contains the anode active material in a state of a plurality of particles (hereinafter referred to as “anode active material particles”). The anode active material particles are formed by, for example, depositing the anode material with the use of the foregoing vapor-phase deposition method or the like. However, the anode active material particles may be formed by a method other than vapor-phase deposition method.

In the case where the anode active material particles are formed by using a deposition method such as vapor-phase deposition method, the anode active material particles may have a single layer structure formed by a single deposition step or may have a multilayer structure formed by a plurality of deposition steps. However, if the anode active material particles are formed by evaporation method or the like associated with high heat in deposition, the anode active material particles preferably have a multilayer structure. In the case where the deposition step of the anode material is divided into several steps (a plurality of thin layers of the anode material are sequentially formed and deposited), time that the anode current collector 22A is exposed at high heat is shortened compared to a case that the deposition is performed in a single deposition step, accordingly the anode current collector 22A is hardly subject to thermal damage.

It is preferable that the anode active material particles are grown, for example, in the thickness direction of the anode active material layer 22B from the surface of the anode current collector 22A, and the anode active material particles are linked to the surface of the anode current collector 22A at the root thereof. Thereby, expansion and shrinkage of the anode active material layer 22B are inhibited in charge and discharge. In this case, it is preferable that the anode active material particles are formed by vapor-phase deposition method or the like, and at least part of the interface with the anode current collector 22A is alloyed. More specifically, at the interface in between, the element of the anode current collector 22A may be diffused in the anode active material particles; or the element of the anode active material particles may be diffused in the anode current collector 22A; or the respective elements may be diffused in each other.

In the case where the anode active material layer 22B contains the plurality of anode active material particles, the anode active material layer 22B preferably contains a metal material not being alloyed with lithium ions in a gap therein. Thereby, the plurality of anode active materials are bound to each other with the metal material in between. In addition, in the case where the metal material exists in the foregoing gap, expansion and shrinkage of the anode active material layer 22B are inhibited.

The metal material has, for example, a metal element not being alloyed with lithium ions as an element. Examples of such metal elements include one or more of nickel, cobalt, iron, zinc, and copper. Specially, one or more of nickel, cobalt, and iron is preferable, since thereby the metal material easily intrudes into the foregoing gap, and superior binding characteristics are obtained. It is needless to say that the metal material may have a metal element other than the foregoing iron and the like. However, “metal material” herein is a comprehensive term, including not only a simple substance but also an alloy and a metal compound.

The metal material is formed by, for example, vapor-phase deposition method or liquid-phase deposition method. Specially, the metal material is preferably formed by liquid-phase deposition method, since thereby the metal material easily intrudes into the gap in the anode active material layer 22B. Examples of liquid-phase deposition methods include electrolytic plating method and non-electrolytic plating method. Specially, electrolytic plating method is preferable, since thereby the metal material more easily intrudes into the foregoing gap, and the formation time thereof is shortened. The metal material may be formed by a single method out of the foregoing formation methods, or may be formed by two or more methods thereof.

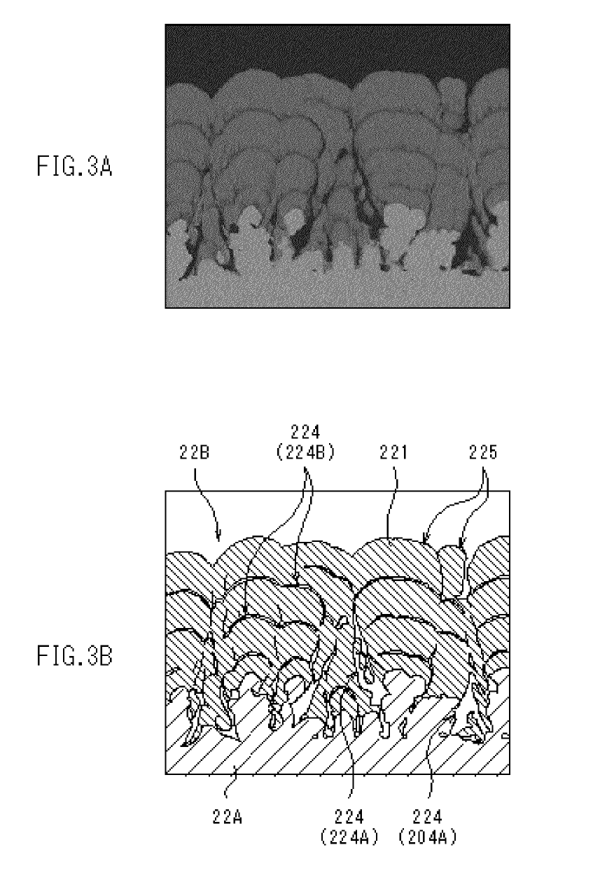

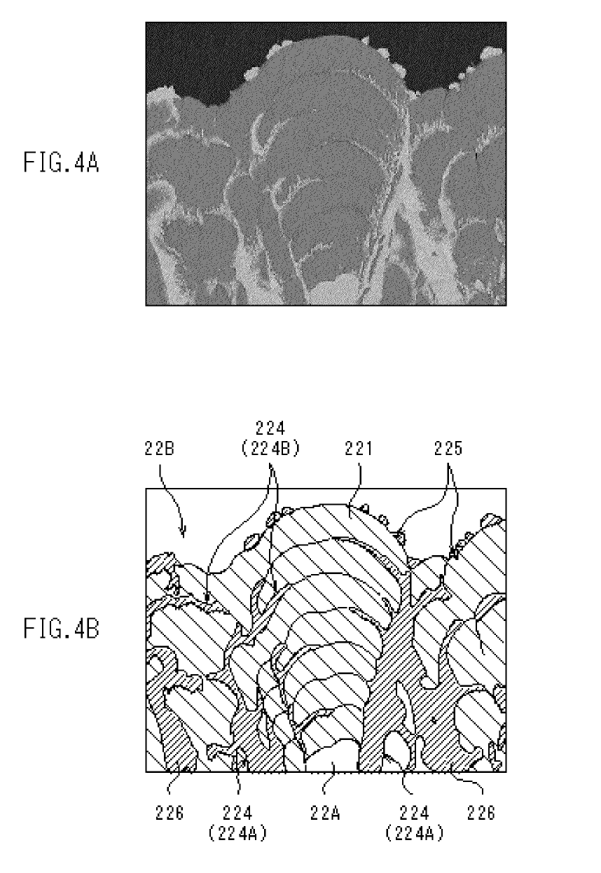

A description will be given of a detailed structure of the anode 22 with reference to FIG. 3A to FIG. 4B.

FIGS. 3A and 3B illustrate an enlarged cross sectional structure of the anode. FIG. 3A is a Scanning Electron Microscope (SEM) photograph (secondary electron image), and FIG. 3B is a schematic drawing of the SEM image illustrated in FIG. 3A. FIGS. 3A and 3B illustrate a case that a plurality of anode active material particles 221 have a multilayer structure in the particles.

In the case where the anode active material particles 221 have the multilayer structure, a plurality of gaps 224 are generated in the anode active material layer 22B due to the arrangement structure, the multilayer structure, and the surface structure of the plurality of anode active material particles 221. The gap 224 mainly includes two types of gaps 224A and 224B categorized according to the cause of generation. The gap 224A is a gap generated between adjacent anode active material particles 221. Meanwhile, the gap 224B is a gap generated between each layer in the anode active material particles 221.

On the exposed face (outermost surface) of the anode active material particle 221, a void 225 is generated in some cases. As a fibrous minute projection section (not illustrated) is generated on the surface of the anode active material particles 221, the void 225 is generated between the projection sections. The void 225 may be generated entirely over the exposed face of the anode active material particles 221, or may be generated in only part thereof. Since the foregoing fibrous projection section is generated every time the anode material is deposited, the void 225 is generated between each layer in addition to on the exposed face of the anode active material particles 221 in some cases.

FIGS. 4A and 4B illustrate another cross sectional structure of the anode, and correspond to FIGS. 3A and 3B. The anode active material layer 22B has a metal material 226 not being alloyed with lithium ions in the gaps 224A and 224B. In this case, only one of the gaps 224A and 224B may have the metal material 226, but both the gaps 224A and 224B preferably have the metal material 226, since thereby higher effect is obtained.

The metal material 226 intrudes into the gap 224A between adjacent anode active material particles 221. More specifically, in the case where the anode active material particles 221 are formed by vapor-phase deposition method or the like, the anode active material particles 221 are grown for every projection section existing on the surface of the anode current collector 22A as described above, and thus the gap 224A is generated between the adjacent anode active material particles 221. The gap 224A causes lowering of the binding characteristics of the anode active material layer 22B. Therefore, to improve the binding characteristics, the metal material 226 fills in the foregoing gap 224A. In this case, it is enough that part of the gap 224A is filled therewith, but the larger filling amount is preferable, since thereby the binding characteristics of the anode active material layer 22B are more improved. The filling amount of the metal material 226 is preferably 20% or more, more preferably 40% or more, and much more preferably 80% or more.

Further, the metal material 226 intrudes into the gap 224B in the anode active material particles 221. More specifically, in the case where the anode active material particles 221 have a multilayer structure, the gap 224B is generated between each layer. The gap 224B causes lowering of the binding characteristics of the anode active material layer 22B as the foregoing gap 224A does. Therefore, to improve the binding characteristics, the metal material 226 fills in the foregoing gap 224B. In this case, it is enough that part of the gap 224B is filled therewith, but the larger filling amount is preferable, since thereby the binding characteristics of the anode active material layer 22B are more improved.

To prevent the fibrous minute projection section (not illustrated) generated on the exposed face (the uppermost surface) of the anode active material particles 221 from adversely affecting the performance of the anode, the void 225 may have the metal material 226. More specifically, in the case where the anode active material particles 221 are formed by vapor-phase deposition method or the like, the fibrous minute projection sections are generated on the surface thereof, and thus the void 225 is generated between the projection sections. The void 225 causes increase of the surface area of the anode active material particles 221, and accordingly the amount of an irreversible coat formed on the surface is also increased, possibly resulting in lowering of progression of charge and discharge reaction. Therefore, to inhibit the lowering of progression of the charge and discharge reaction, the foregoing void 225 is filled with the metal material 226. In this case, it is enough at minimum that part of the void 225 is filled therewith, but the larger filling amount is preferable, since thereby the lowering of progression of the charge and discharge reaction is more inhibited. In FIGS. 4A and 4B, the metal material 226 is dotted on the exposed face of the anode active material particles 221, which means that the foregoing minute projection section exists in the location where the metal material 226 is dotted. It is needless to say that the metal material 226 is not necessarily dotted on the surface of the anode active material particles 221, but may cover the entire surface thereof.

In particular, the metal material 226 that intrudes into the gap 224B has a function to fill in the void 205 in each layer. More specifically, in the case where the anode material is deposited several times, the foregoing minute projection section is generated for every deposition. Therefore, the metal material 226 fills in not only the gap 224B in each layer, but also the void 225 in each layer.

In FIGS. 3A to 4B, the description has been given of a case that the anode active material particles 221 have the multilayer structure, and both gaps 224A and 224B exist in the anode active material layer 22B. Thus, in this case, the anode active material layer 22B has the metal material 226 in the gaps 224A and 224B. Meanwhile, in the case where the anode active material particles 221 have a single layer structure, and only the gap 224A exists in the anode active material layer 22B, the anode active material layer 22B has the metal material 226 only in the gap 224A. It is needless to say that the void 225 is generated in both cases, and thus in any case, the metal material 226 is included in the void 225.

The anode active material layer 22B may also contain other anode material capable of inserting and extracting lithium ions as long as the anode active material layer 22B contains the material having silicon as an element.

Examples of such other anode materials include a material that contains one or more of metal elements and metalloid elements as an element other than silicon. By using such a material, a high energy density is obtained. Examples of such a material include a simple substance, an alloy, or a compound of a metal element or a metalloid element, and a material having one or more phases thereof at least in part.

Examples of the foregoing metal element or the foregoing metalloid element include a metal element or a metalloid element capable of forming an alloy with lithium. Specific examples thereof include magnesium (Mg), boron, aluminum, gallium, indium, germanium, tin, lead, bismuth, cadmium (Cd), silver, zinc, hafnium, zirconium, yttrium (Y), palladium (Pd), and platinum (Pt). Specially, a metal element or a metalloid element in Group 4B in the long period periodic table is preferable, and tin is more preferable. Tin has a high ability to insert and extract lithium ions, and provides a high energy density. The long period periodic table is shown in Inorganic Chemical Nomenclature (revised version) advocated by International Union of Pure and Applied Chemistry (IUPAC).

Examples of materials having tin as an element include a simple substance, an alloy, or a compound of tin, or a material having one or more phases thereof at least in part.

Examples of alloys of tin include an alloy having one or more of silicon, nickel, copper, iron, cobalt, manganese, zinc, indium, silver, titanium, germanium, bismuth, antimony, and chromium as a second element other than tin. Examples of compounds of tin include a compound having oxygen or carbon. The compound of tin may have the foregoing second element. Examples of alloys or compounds of tin include SnSiO₃, LiSnO, and Mg₂Sn.

In particular, examples of materials having tin as an element include a material having a second element and a third element in addition to tin as a first element. The second element is one or more of cobalt, iron, magnesium, titanium, vanadium, chromium, manganese, nickel, copper, zinc, gallium, zirconium, niobium, molybdenum, silver, indium, cerium (Ce), hafnium, tantalum, tungsten, bismuth, and silicon. The third element is one or more of boron, carbon, aluminum, and phosphorus (P). In the case where the second element and the third element are contained, the cycle characteristics are improved.

Specially, an SnCoC-containing material that contains tin, cobalt, and carbon as an element, in which the carbon content is from 9.9 wt % to 29.7 wt % both inclusive, and the cobalt ratio to the total of tin and cobalt (Co/(Sn+Co)) is from 30 wt % to 70 wt % both inclusive, is preferable, since such an SnCoC-containing material is able to provide a high energy density.

The SnCoC-containing material may further have other element according to needs. As other element, for example, silicon, iron, nickel, chromium, indium, niobium, germanium, titanium, molybdenum, aluminum, phosphorus, gallium, bismuth or the like is preferable. Two or more thereof may be contained, since thereby higher effect is obtained.

The SnCoC-containing material contains a phase having tin, cobalt, and carbon. Such a phase preferably has a low crystalline structure or an amorphous structure. The phase is a reaction phase capable of being reacted with lithium ions. The half bandwidth of the diffraction peak obtained by X-ray diffraction of the phase is preferably 1.0 deg or more based on diffraction angle of 2θ in the case where CuKα ray is used as a specific X ray, and the insertion rate is 1 deg/min. Thereby, lithium ions are more smoothly inserted and extracted, and reactivity with the electrolyte is decreased.

In addition to the SnCoC-containing material, an SnCoFeC-containing material having tin, cobalt, iron, and carbon as an element is also preferable. The composition of the SnCoFeC-containing material is able to be voluntarily set. For example, as a composition in which the iron content is set small, it is preferable that the carbon content is from 9.9 wt % to 29.7 wt % both inclusive, the iron content is from 0.3 wt % to 5.9 wt % both inclusive, and the cobalt ratio to the total of tin and cobalt (Co/(Sn+Co)) is from 30 wt % to 70 wt % both inclusive. Further, for example, as a composition in the case where the iron content is set large, it is preferable that the carbon content is from 11.9 wt % to 29.7 wt % both inclusive, the ratio of the total of cobalt and iron to the total of tin, cobalt, and iron ((Co+Fe)/(Sn+Co+Fe)) is from 26.4 wt % to 48.5 wt % both inclusive, and the cobalt ratio to the total of cobalt and iron (Co/(Co+Fe)) is from 9.9 wt % to 79.5 wt % both inclusive. In such a composition range, a high energy density is obtained.

Examples of other anode material include a carbon material. In the carbon material, crystal structure change associated with insertion and extraction of lithium ions is extremely small. Thus, the carbon material provides a high energy density, and functions as an electrical conductor as well. Examples of carbon materials include graphitizable carbon, non-graphitizable carbon in which the spacing of (002) plane is 0.37 nm or more, and graphite in which the spacing of (002) plane is 0.34 nm or less. More specifically, examples of carbon materials include pyrolytic carbon, coke, graphite, glassy carbon fiber, an organic polymer compound fired body, carbon fiber, activated carbon, and carbon black. Of the foregoing, the coke includes pitch coke, needle coke, petroleum coke and the like. The graphite includes natural graphite and artificial graphite such as meso-carbon micro beads (MCMB). The organic polymer compound fired body is obtained by firing and carbonizing a phenol resin, a furan resin or the like at appropriate temperature. The shape of the carbon material may be any of a fibrous shape, a spherical shape, a granular shape, and a scale-like shape.

Further, examples of other anode materials include a metal compound and a polymer compound capable of inserting and extracting lithium ions. Examples of metal compounds include a metal oxide such as iron oxide, ruthenium oxide, and molybdenum oxide; a metal sulfide such as nickel sulfide and molybdenum sulfide; and a metal nitride such as lithium nitride. Examples of polymer compounds include polyacetylene, polyaniline, and polypyrrole.

It is needless to say that as an anode material capable of inserting and extracting lithium ions, an anode material other than the foregoing material may be used. Two or more of the foregoing anode materials may be used by mixture voluntarily, as long as the material having silicon as an element is contained.

The maximum usage ratio in the fully charged state of the anode 22 (hereinafter simply referred to as “usage ratio”) is set to from 20% to 70% both inclusive by adjusting the ratio between the capacity of the cathode 21 and the capacity of the anode 22, since thereby superior cycle characteristics, superior initial charge and discharge characteristics, and superior swollenness characteristics are obtained.

The foregoing “usage ratio” is expressed by usage ratio Z (%)=(X/Y)*100. In the formula, X represents a lithium ion insertion amount per unit area in the fully charged state of the anode 22, and Y represents a lithium ion amount capable of being electrochemically inserted into the anode 22 per unit area.

The insertion amount X is able to be obtained by, for example, the following procedure. First, after the secondary battery is charged to become in the fully charged state, the secondary battery is disassembled, and the section opposed to the cathode 21 out of the anode 22 (inspection anode) is cut out. Subsequently, by using the inspection anode, an evaluation battery in which a metal lithium is a counter electrode is assembled. Finally, the evaluation battery is discharged and the discharge capacity in the initial discharge is measured. After that, the discharge capacity is divided by the area of the inspection anode to calculate the insertion amount X. “Discharge” in this case means applying a current in the direction in which lithium ions are extracted from the inspection anode. For example, constant current discharge is performed at a current density of 0.1 mA/cm² until the battery voltage reaches 1.5 V.

Meanwhile, the insertion amount Y is obtained by, for example, as follows. The foregoing evaluation battery that has been already discharged is charged under a constant current and a constant voltage until the battery voltage becomes OV to measure the charge capacity. After that, the charge capacity is divided by the area of the inspection anode. “Charge” in this case means applying a current in the direction in which lithium ions are inserted into the inspection anode. For example, in constant voltage charge in which a current density is 0.1 mA/cm² and a battery voltage is 0 V, charge is performed until the current density reaches 0.02 mA/cm².

The separator 23 separates the cathode 21 from the anode 22, and passes lithium ions while preventing short circuit resulting from contact of both electrodes. The separator 23 is made of, for example, a porous film composed of a polymer compound (synthetic resin) such as polyethylene, polypropylene, and polytetrafluoroethylene, or a ceramics porous film.

The separator 23 may have a single layer structure or a multilayer structure. Examples of the separator 23 having a single layer structure include a polyethylene porous film. Examples of the separator 23 having a multilayer structure include a separator having a polymer compound layer different from the foregoing porous film composed of the polymer compound on the foregoing porous film composed of the polymer compound. Specific examples of the separator 23 include a three layer structure such as polypropylene/polyethylene/polypropylene structure, polyvinylidene fluoride/polyethylene/polyvinylidene fluoride structure, and aramid/polyethylene/aramid structure. In the case where the separator 23 has the foregoing polymer compound layer on the porous film, for example, the polymer compound layer may contain a plurality of insulating particles. Examples of the insulating particles include silicon oxide (SiO₂).

An electrolytic solution as a liquid electrolyte is impregnated in the separator 23. The electrolytic solution contains a solvent and an electrolyte salt dissolved therein.

The solvent contains, for example, one or more nonaqueous solvents such as an organic solvent. The solvents described below may be combined voluntarily.

Examples of nonaqueous solvents include ethylene carbonate, propylene carbonate, butylene carbonate, dimethyl carbonate, diethyl carbonate, ethyl methyl carbonate, methylpropyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, trimethyl methyl acetate, trimethyl ethyl acetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. Specially, one or more of ethylene carbonate, propylene carbonate, dimethyl carbonate, diethyl carbonate, and ethyl methyl carbonate is preferable. In this case, a combination of a high viscosity (high dielectric constant) solvent (for example, specific inductive ∈≧30) such as ethylene carbonate or propylene carbonate and a low viscosity solvent (for example, viscosity≦1 mPa·s) such as dimethyl carbonate, ethylmethyl carbonate, or diethyl carbonate is more preferable. Thereby, dissociation characteristics of the electrolyte salt and ion mobility are improved.

In particular, the solvent preferably contains one or more of cyclic ester carbonates having an unsaturated carbon bond shown in Formula 2 to Formula 4. Thereby, a stable protective film is formed on the surface of the anode 22 in charge and discharge, and thus decomposition of the electrolyte is inhibited.

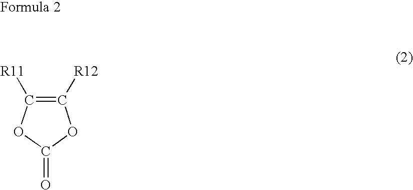

In the formula, R11 and R12 are a hydrogen group or an alkyl group.

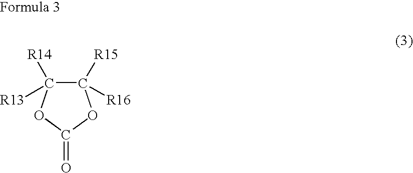

In the formula, R13 to R16 are a hydrogen group, an alkyl group, a vinyl group, or an aryl group. One or more of R13 to R16 is the vinyl group or the aryl group.

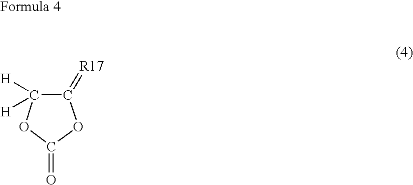

In the formula, R17 is an alkylene group.

The cyclic ester carbonate having an unsaturated carbon bond shown in Formula 2 is a vinylene carbonate compound. Examples of vinylene carbonate compounds include vinylene carbonate (1,3-dioxole-2-one), methylvinylene carbonate (4-methyl-1,3-dioxole-2-one), ethylvinylene carbonate (4-ethyl-1,3-dioxole-2-one), 4,5-dimethyl-1,3-dioxole-2-one, 4,5-diethyl-1,3-dioxole-2-one, 4-fluoro-1,3-dioxole-2-one, and 4-trifluoromethyl-1,3-dioxole-2-one. Specially, vinylene carbonate is preferable, since vinylene carbonate is easily available and provides high effect.

The cyclic ester carbonate having an unsaturated carbon bond shown in Formula 3 is a vinylethylene carbonate compound. Examples of vinylethylene carbonate compounds include vinylethylene carbonate (4-vinyl-1,3-dioxolane-2-one), 4-methyl-4-vinyl-1,3-dioxolane-2-one, 4-ethyl-4-vinyl-1,3-dioxolane-2-one, 4-n-propyl-4-vinyl-1,3-dioxolane-2-one, 5-methyl-4-vinyl-1,3-dioxolane-2-one, 4,4-divinyl-1,3-dioxolane-2-one, and 4,5-divinyl-1,3-dioxolane-2-one. Specially, vinylethylene carbonate is preferable, since vinylethylene carbonate is easily available, and provides high effect. It is needless to say that all of R13 to R16 may be the vinyl group or the aryl group. Otherwise, it is possible that some of R13 to R16 are the vinyl group, and the others thereof are the aryl group.

The cyclic ester carbonate having an unsaturated carbon bond shown in Formula 4 is a methylene ethylene carbonate compound. Examples of methylene ethylene carbonate compounds include 4-methylene-1,3-dioxolane-2-one, 4,4-dimethyl-5-methylene-1,3-dioxolane-2-one, and 4,4-diethyl-5-methylene-1,3-dioxolane-2-one. The methylene ethylene carbonate compound may have one methylene group (compound shown in Formula 4), or have two methylene groups.

The cyclic ester carbonate having an unsaturated carbon bond may be catechol carbonate having a benzene ring or the like, in addition to the compounds shown in Formula 2 to Formula 4.

The solvent preferably contains one or both of a chain ester carbonate having halogen as an element shown in Formula 5 and a cyclic ester carbonate having halogen as an element shown in Formula 6. Thereby, in charge and discharge, a stable protective film is formed on the surface of the anode 22 and decomposition of the electrolyte is inhibited.

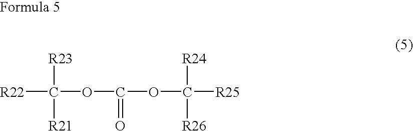

In the formula, R21 to R26 are a hydrogen group, a halogen group, an alkyl group, or an alkyl halide group. One or more of R21 to R26 is the halogen group or the alkyl halide group.

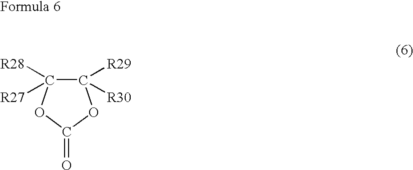

In the formula, R27 to R30 are a hydrogen group, a halogen group, an alkyl group, or an alkyl halide group. One or more of R27 to R30 is the halogen group or the alkyl halide group.

R21 to R26 in Formula 5 may be identical or different. That is, types of R21 to R26 are able to be individually set in the range of the foregoing groups. The same is applied to R27 to R30 in Formula 6.

The halogen type is not particularly limited, but in particular, is preferably fluorine, chlorine, or bromine. Fluorine is more preferable, since higher effect is thereby obtained compared to other halogen. The number of halogen is more preferably two than one, and further may be three or more, since thereby an ability to form a protective film is improved, and a more rigid and more stable protective film is formed. Accordingly, decomposition reaction of the electrolytic solution is more inhibited.

Examples of the chain ester carbonate having halogen as an element shown in Formula 5 include fluoromethyl methyl carbonate, bis(fluoromethyl) carbonate, and difluoromethyl methyl carbonate. One thereof may be used singly, or a plurality thereof may be used by mixture.

Examples of the cyclic ester carbonate having halogen as an element shown in Formula 6 include the compounds shown in Formula 6-1 to Formula 6-21 described below. That is, examples thereof include 4-fluoro-1,3-dioxolane-2-one, 4-chloro-1,3-dioxolane-2-one, 4,5-difluoro-1,3-dioxolane-2-one, tetrafluoro-1,3-dioxolane-2-one, 4-chloro-5-fluoro-1,3-dioxolane-2-one, 4,5-dichloro-1,3-dioxolane-2-one, tetrachloro-1,3-dioxolane-2-one, 4,5-bistrifluoromethyl-1,3-dioxolane-2-one, 4-trifluoromethyl-1,3-dioxolane-2-one, 4,5-difluoro-4,5-dimethyl-1,3-dioxolane-2-one, 4,4-difluoro-5-methyl-1,3-dioxolane-2-one, 4-ethyl-5,5-difluoro-1,3-dioxolane-2-one, 4-fluoro-5-trifluoromethyl-1,3-dioxolane-2-one, 4-methyl-5-trifluoro-methyl-1,3-dioxolane-2-one, 4-fluoro-4,5-dimethyl-1,3-dioxolane-2-one, 5-(1,1-difluoroethyl)-4,4-difluoro-1,-dioxolane-2-one, 4,5-dichloro-4,5-dimethyl-1,3-dioxolane-2-one, 4-ethyl-5-fluoro-1,3-dioxolane-2-one, 4-ethyl-4,5-difluoro-1,3-dioxolane-2-one, 4-ethyl-4,5,5-trifluoro-1,3-dioxolane-2-one, and 4-fluoro-4-methyl-1,3-dioxolane-2-one. One thereof may be used singly, or a plurality thereof may be used by mixture.

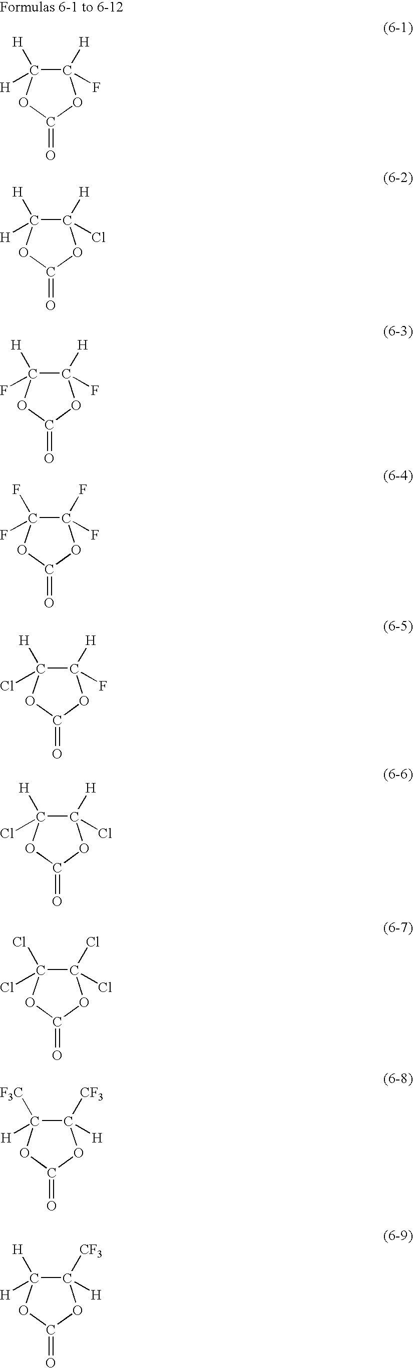

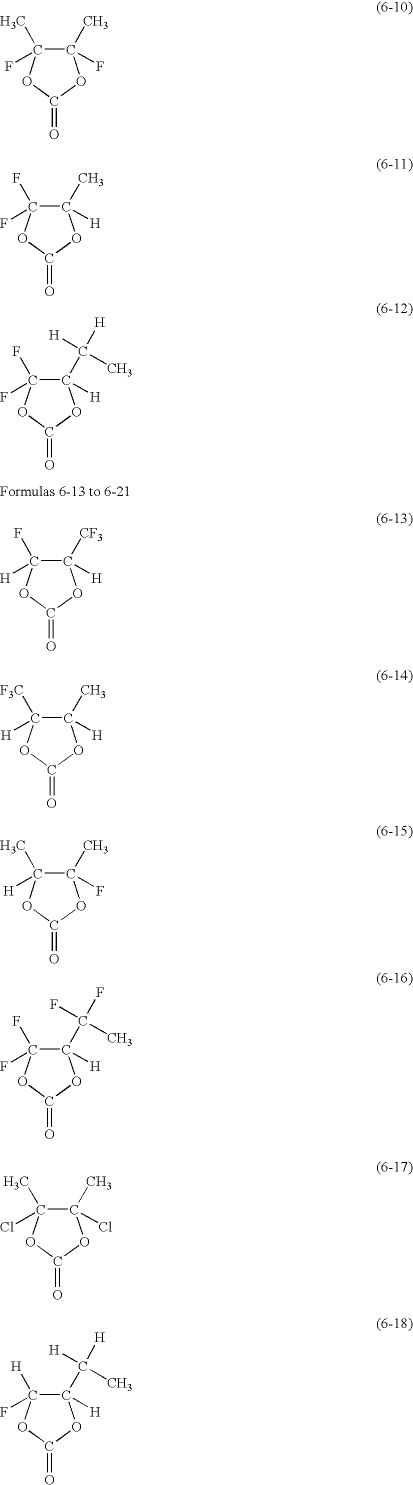

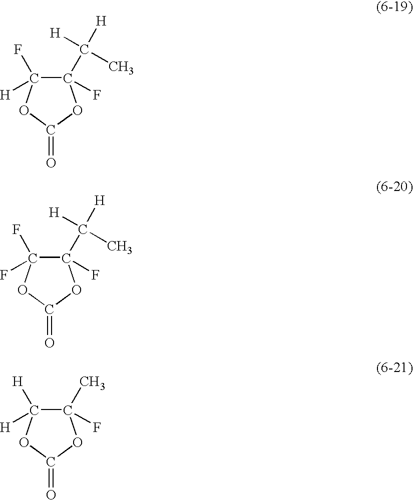

Specially, 4-fluoro-1,3-dioxolane-2-one or 4,5-difluoro-1,3-dioxolane-2-one is preferable, and 4,5-difluoro-1,3-dioxolane-2-one is more preferable. In particular, as 4,5-difluoro-1,3-dioxolane-2-one, a trans isomer is more preferable than a cis isomer, since the trans isomer is easily available and provides high effect.

Further, the solvent preferably contains sultone (cyclic sulfonic ester), since thereby chemical stability of the electrolyte is more improved. Examples of sultone include propane sultone and propene sultone. Such sultone may be used singly, or a plurality thereof may be used by mixture. The sultone content in the solvent is, for example, from 0.5 wt % to 5 wt % both inclusive.

Further, the solvent preferably contains an acid anhydride, since thereby chemical stability of the electrolytic solution is more improved. Examples of acid anhydrides include carboxylic anhydride such as succinic anhydride, glutaric anhydride, and maleic anhydride; disulfonic anhydride such as ethane disulfonic anhydride and propane disulfonic anhydride; and an anhydride of carboxylic acid and sulfonic acid such as sulfobenzoic anhydride, sulfopropionic anhydride, and sulfobutyric anhydride. The anhydrides may be used singly, or a plurality thereof may be used by mixture. The content of the acid anhydride in the solvent is, for example, from 0.5 wt % to 5 wt % both inclusive.

The electrolyte salt contains, for example, one or more light metal salts such as a lithium salt. The electrolyte salts described below may be combined voluntarily.

Examples of lithium salts include lithium hexafluorophosphate, lithium tetrafluoroborate, lithium perchlorate, lithium hexafluoroarsenate, lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr).

Specially, one or more of lithium hexafluorophosphate, lithium tetrafluoroborate, lithium perchlorate, and lithium hexafluoroarsenate is preferable, and lithium hexafluorophosphate is more preferable, since the internal resistance is lowered, and thus higher effect is obtained.

In particular, the electrolyte salt preferably contains one or more of the compounds shown in Formula 7 to Formula 9, since thereby higher effect is obtained. R31 and R33 in Formula 7 may be identical or different. The same is applied to R41 to R43 in Formula 8 and R51 and R52 in Formula 9.

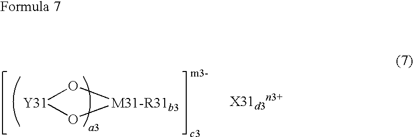

In the formula, X31 is a Group 1 element or a Group 2 element in the long period periodic table or aluminum. M31 is a transition metal element, a Group 13 element, a Group 14 element, or a Group 15 element in the long period periodic table. R31 is a halogen group. Y31 is —(O═)C—R32-C(═O)—, —(O═)C—C(R33)₂-, or —(O═)C—C(═O)—. R32 is an alkylene group, an alkylene halide group, an arylene group, or an arylene halide group. R33 is an alkyl group, an alkyl halide group, an aryl group, or an aryl halide group. a3 is one of integer numbers 1 to 4. b3 is 0, 2, or 4. c3, d3, m3, and n3 are one of integer numbers 1 to 3.

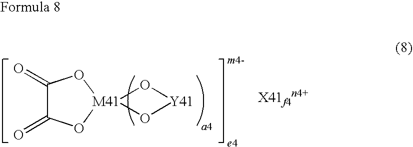

In the formula, X41 is a Group 1 element or a Group 2 element in the long period periodic table. M41 is a transition metal element, a Group 13 element, a Group 14 element, or a Group 15 element in the long period periodic table. Y41 is —(O═)C—(C(R41)₂)_{b4}-C(═O)—, —(R43)₂C—(C(R42)₂)_{c4}-C(═O)—, —(R43)₂C—(C(R42)₂)_{c4}-C(R43)₂-, —(R43)₂C—(C(R42)₂)_{c4}-S(═O)₂—, —(O═)₂S—(C(R42)₂)_{d4}-S(═O)₂—, or —(O═)C—(C(R42)₂)_{d4}-S(═O)₂—. R41 and R43 are a hydrogen group, an alkyl group, a halogen group, or an alkyl halide group. One or both of R41 and R43 is respectively the halogen group or the alkyl halide group. R42 is a hydrogen group, an alkyl group, a halogen group, or an alkyl halide group. a4, e4, and n4 are 1 or 2. b4 and d4 are one of integer numbers 1 to 4. c4 is one of integer numbers 0 to 4. f4 and m4 are one of integer numbers 1 to 3.

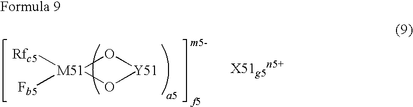

In the formula, X51 is a Group 1 element or a Group 2 element in the long period periodic table. M51 is a transition metal element, a Group 13 element, a Group 14 element, or a Group 15 element in the long period periodic table. Rf is a fluorinated alkyl group with the carbon number of from 1 to 10 both inclusive or a fluorinated aryl group with the carbon number of from 1 to 10 both inclusive. Y51 is —(O═)C—(C(R51)₂)_{d5}-C(═O)—, —(R52)₂C—(C(R51)₂)_{d5}-C(═O)—, —(R52)₂C—(C(R51)₂)_{d5}-C(R52)₂-, —(R52)₂C—(C(R51)₂)_{d5}-S(═O)₂—, —(O═)₂S—(C(R51)₂)_{c5}-S(═O)₂—, or —(O)C—(C(R51)₂)_{c5}-S(═O)₂—. R51 is a hydrogen group, an alkyl group, a halogen group, or an alkyl halide group. R52 is a hydrogen group, an alkyl group, a halogen group, or an alkyl halide group, and one or more thereof is the halogen group or the alkyl halide group. a5, f5, and n5 are 1 or 2. b5, c5, and e5 are one of integer numbers 1 to 4. d5 is one of integer numbers 0 to 4. g5 and m5 are one of integer numbers 1 to 3.

Group 1 element represents hydrogen, lithium, sodium, potassium, rubidium, cesium, and francium. Group 2 element represents beryllium, magnesium, calcium, strontium, barium, and radium. Group 13 element represents boron, aluminum, gallium, indium, and thallium Group 14 element represents carbon, silicon, germanium, tin, and lead. Group 15 element represents nitrogen, phosphorus, arsenic, antimony, and bismuth.

Examples of the compound shown in Formula 7 include the compounds shown in Formula 7-1 to Formula 7-6. Examples of the compound shown in Formula 8 include the compounds shown in Formula 8-1 to Formula 8-8. Examples of the compound shown in Formula 9 include the compound shown in Formula 9-1. It is needless to say that the compound is not limited to the foregoing compounds as long as the compound has the structure shown in Formula 7 to Formula 9.

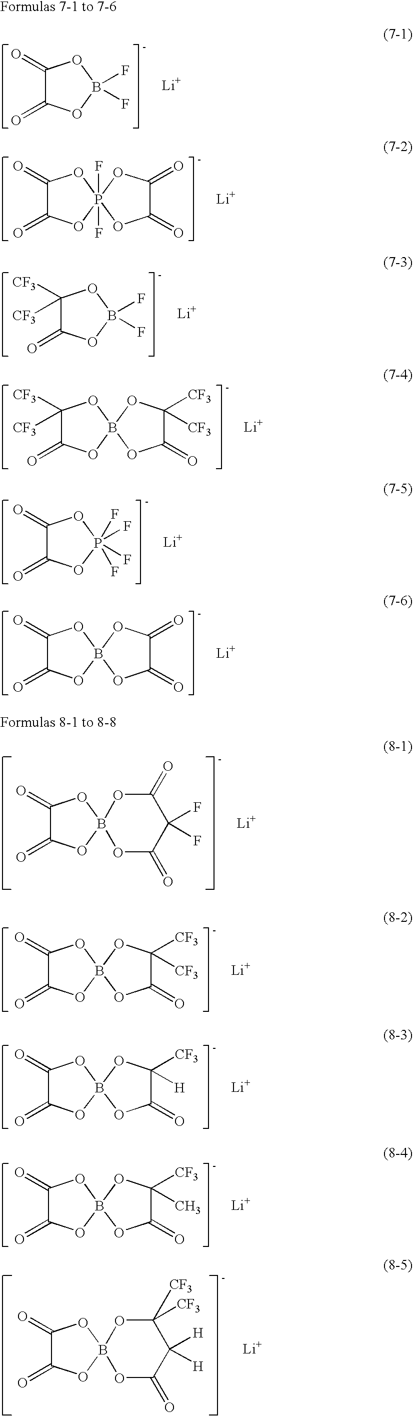

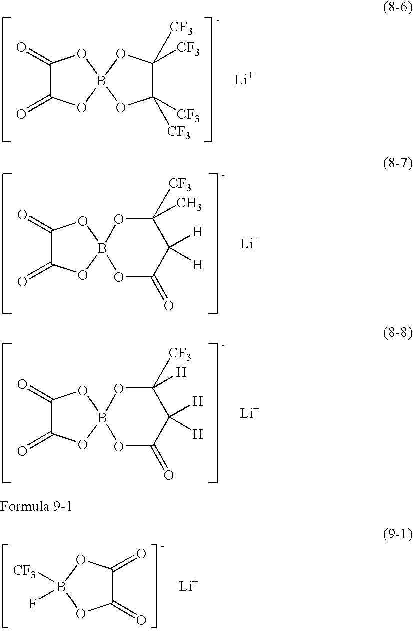

Further, the electrolyte salt may contain one or more of the compounds shown in Formula 10 to Formula 12. Thereby, higher effect is obtained. m and n in Formula 10 may be identical or different. The same is applied to p, q, and r in Formula 12.

Formula 10

LiN(CₘF₂ₘ₊₁SO₂)(CₙF₂ₙ₊₁SO₂) (10)

In the formula, m and n are an integer number of 1 or more.

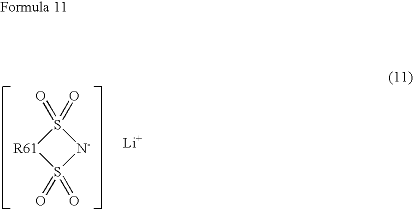

In the formula, R61 is a straight chain/branched perfluoro alkylene group with the carbon number of from 2 to 4 both inclusive.

Formula 12

LiC(CₚF₂ₚ₊₁SO₂)(C_{q}F_{2q+1}SO₂)(CᵣF₂ᵣ₊₁SO₂) (12)

In the formula, p, q, and r are an integer number of 1 or more.

Examples of the chain compound shown in Formula 10 include lithium bis(trifluoromethanesulfonyl)imido (LiN(CF₃SO₂)₂), lithium bis(pentafluoroethanesulfonyl)imido (LiN(C₂F₅SO₂)₂), lithium (trifluoromethanesulfonyl)(pentafluoroethanesulfonyl)imido (LiN(CF₃SO₂)(C₂F₅SO₂)), lithium(trifluoromethanesulfonyl)(heptafluoropropanesulfonyl)imido (LiN(CF₃SO₂)(C₃F₇SO₂)), and lithium(trifluoromethanesulfonyl)(nonafluorobutanesulfonyl)imido (LiN(CF₃SO₂)(C₄F₉SO₂)). One thereof may be used singly, or a plurality thereof may be used by mixture.

Examples of the cyclic compound shown in Formula 11 include the compounds shown in Formula 11-1 to Formula 11-4 described below. That is, examples thereof include 1,2-perfluoroethanedisulfonyl imido lithium, 1,3-perfluoropropanedisulfonyl imido lithium, 1,3-perfluorobutanedisulfonyl imido lithium, and 1,4-perfluorobutanedisulfonyl imido lithium. One thereof may be used singly, or a plurality thereof may be used by mixture.

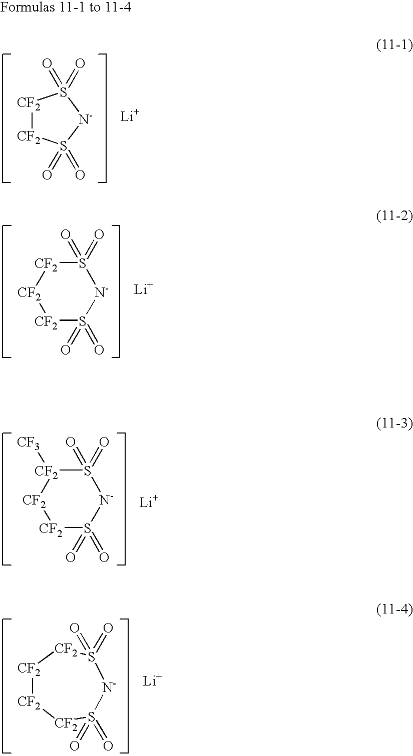

Examples of the chain compound shown in Formula 12 include lithium tris(trifluoromethanesulfonyl)methyde (LiC(CF₃SO₂)₃).

The content of the electrolyte salt to the solvent is preferably from 0.3 mol/kg to 3.0 mol/kg both inclusive. Thereby, high ion conductivity is obtained.

In the secondary battery, in charge, for example, lithium ions are extracted from the cathode 21, and are inserted in the anode 22 through the electrolytic solution impregnated in the separator 23. Meanwhile, in discharge, for example, lithium ions are extracted from the anode 22, and are inserted in the cathode 21 through the electrolytic solution impregnated in the separator 23.

At this time, the upper voltage in charge is preferably 4.18 V or less. Further, the cutoff voltage in discharge is preferably 3.0 V or less. Thereby, even if the thickness of the anode active material layer 22B is increased, superior cycle characteristics are obtained without largely lowering the battery capacity.

The secondary battery is manufactured, for example, by the following procedure.

First, the cathode 21 is formed. First, a cathode active material, a cathode binder, and a cathode electrical conductor are mixed to prepare a cathode mixture, which is dispersed in an organic solvent to form a paste cathode mixture slurry. Subsequently, both faces of the cathode current collector 21A are uniformly coated with the cathode mixture slurry by using a doctor blade, a bar coater or the like, which is dried by volatilizing the organic solvent. Thereby, the cathode active material layer 21B is formed. Finally, the cathode active material layer 21B is compression-molded by using a rolling press machine or the like while being heated if necessary. In this case, the resultant may be compression-molded over several times.

Next, the anode 22 is formed. First, the anode current collector 22A made of an electrolytic copper foil or the like is prepared. After that, an anode material is deposited on both faces of the anode current collector 22A by using vapor-phase deposition method such as evaporation method, and thereby a plurality of anode active material particles are formed. After that, according to needs, a metal material is formed by liquid-phase deposition method such as electrolytic plating method. Accordingly, the anode active material layer 22B is formed.

The secondary battery is assembled as follows. First, after the battery element 20 is contained in the battery can 11, the insulating plate 12 is arranged on the battery element 20. Subsequently, the cathode lead 24 is connected to the cathode pin 15 by welding or the like, and the anode lead 25 is connected to the battery can 11 by welding or the like. After that, the battery cover 13 is fixed on the open end of the battery can 11 by laser welding or the like. Finally, the electrolytic solution is injected into the battery can 11 from the injection hole 19, and impregnated in the separator 23. After that, the injection hole 19 is sealed by a sealing member 19A. The secondary battery illustrated in FIG. 1 and FIG. 2 is thereby completed.

According to the secondary battery of this embodiment, the cathode 21 and the anode 22 satisfy the following four conditions A to D:

A. The cathode active material layer 21B of the cathode 21 contains the cathode active material (lithium-nickel based composite oxide) being capable of inserting and extracting lithium ions and being expressed by Formula 1.

B. The anode active material layer 22B of the anode 22 contains the anode active material being capable of inserting and extracting lithium ions and having silicon as an element.

C. The usage ratio in a fully charged state of the anode 22 is from 20% to 70% both inclusive.

D. The thickness of the anode active material layer 22B in a discharged state in the initial charge and discharge is 40 μm or less.

Thereby, while a high energy density is secured, in charge and discharge, decomposition of the electrolyte and dropping or the like of the anode active material layer are inhibited. Therefore, the cycle characteristics, the initial charge and discharge characteristics, and the swollenness characteristics are able to be improved.

Further, in the case where the solvent of the electrolyte contains the cyclic ester carbonate having an unsaturated carbon bond, the chain ester carbonate having halogen as an element, the cyclic ester carbonate having halogen as an element, sultone; or an acid anhydride, the cycle characteristics are able to be more improved.

Further, in the case where the electrolyte salt of the electrolyte contains one or more of lithium hexafluorophosphate, lithium tetrafluoroborate, lithium perchlorate, and lithium hexafluoroarsenate; or the compound shown in Formula 7 to Formula 12, the cycle characteristics are able to be more improved.

### Second Embodiment

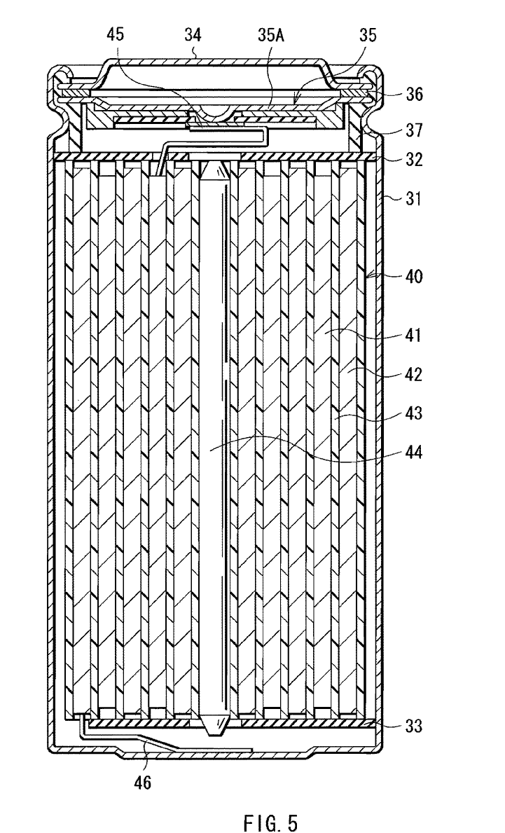

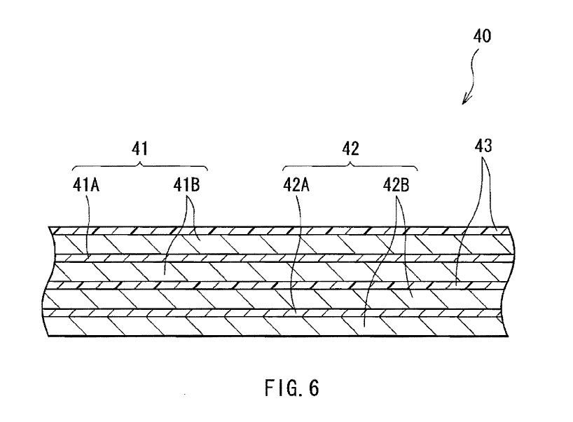

FIG. 5 and FIG. 6 illustrate a cross sectional structure of a secondary battery according to a second embodiment of the invention. FIG. 6 illustrates an enlarged part of a spirally wound electrode body 40 illustrated in FIG. 5.

The secondary battery is a lithium ion secondary battery as in the foregoing first embodiment. The secondary battery contains the spirally wound electrode body 40 and a pair of insulating plates 32 and 33 inside a battery can 31 in the shape of an approximately hollow cylinder. The battery structure using such a battery can 31 is a so-called cylindrical type.

The battery can 31 is made of, for example, a material similar to that of the battery can 11 in the foregoing first embodiment. One end of the battery can 31 is opened, and the other end of the battery can 31 is closed. The pair of insulating plates 32 and 33 is arranged to sandwich the spirally wound electrode body 40 in between and to extend perpendicularly to the spirally wound periphery face.

At the open end of the battery can 31, a battery cover 34, and a safety valve mechanism 35 and a PTC (Positive Temperature Coefficient) device 36 provided inside the battery cover 34 are attached by being caulked with a gasket 37. By the caulking work, inside of the battery can 31 is hermetically sealed. The battery cover 34 is made of, for example, a material similar to that of the battery can 31. The safety valve mechanism 35 is electrically connected to the battery cover 34 through the PTC device 36. In the safety valve mechanism 35, in the case where the internal pressure becomes a certain level or more by internal short circuit, external heating or the like, a disk plate 35A inverts to cut the electric connection between the battery cover 34 and the spirally wound electrode body 40. As temperature rises, the PTC device 36 increases the resistance and thereby limits a current to prevent abnormal heat generation resulting from a large current. The gasket 37 is made of, for example, an insulating material. The surface of the gasket 37 is coated with, for example, asphalt.

In the spirally wound electrode body 40, a cathode 41 and an anode 42 are layered with a separator 43 in between and spirally wound. For example, a center pin 44 is inserted in the center of the spirally wound electrode body 40. In the spirally wound electrode body 40, a cathode lead 45 made of aluminum or the like is connected to the cathode 41, and an anode lead 46 made of nickel or the like is connected to the anode 42. The cathode lead 45 is electrically connected to the battery cover 34 by, for example, being welded to the safety valve mechanism 35. The anode lead 46 is, for example, welded and thereby electrically connected to the battery can 31.

The cathode 41 has a structure in which, for example, a cathode active material layer 41B is provided on both faces of a cathode current collector 41A having a pair of faces. The anode 42 has a structure in which, for example, an anode active material layer 42B is provided on both faces of an anode current collector 42A having a pair of faces. The structures of the cathode current collector 41A, the cathode active material layer 41B, the anode current collector 42A, the anode active material layer 42B, and the separator 43 and the composition of the electrolytic solution are respectively similar to the structures of the cathode current collector 21A, the cathode active material layer 21B, the anode current collector 22A, the anode active material layer 22B, and the separator 23, and the composition of the electrolytic solution in the foregoing first embodiment.

In the secondary battery, in charge, for example, lithium ions are extracted from the cathode 41, and are inserted in the anode 42 through the electrolytic solution. Meanwhile, in discharge, for example, lithium ions are extracted from the anode 42, and are inserted in the cathode 41 through the electrolytic solution.

The secondary battery is manufactured, for example, by the following procedure.

First, for example, the cathode 41 is formed by forming the cathode active material layer 41B on both faces of the cathode current collector 41A and the anode 42 is formed by forming the anode active material layer 42B on both faces of the anode current collector 42A with the use of procedures similar to the procedures of forming the cathode 21 and the anode 22 in the foregoing first embodiment. Subsequently, the cathode lead 45 is attached to the cathode 41 by welding or the like, and the anode lead 46 is attached to the anode 42 by welding or the like. Subsequently, the cathode 41 and the anode 42 are layered with the separator 43 in between and spirally wound, and thereby the spirally wound electrode body 40 is formed. After that, the center pin 44 is inserted in the center of the spirally wound electrode body. Subsequently, the spirally wound electrode body 40 is sandwiched between the pair of insulating plates 32 and 33, and contained in the battery can 31. In this case, the end of the cathode lead 45 is welded to the safety valve mechanism 35, and the end of the anode lead 46 is welded to the battery can 31. Subsequently, the electrolytic solution is injected into the battery can 31 and impregnated in the separator 43. Finally, at the open end of the battery can 31, the battery cover 34, the safety valve mechanism 35, and the PTC device 36 are fixed by being caulked with the gasket 37. The secondary battery illustrated in FIG. 5 and FIG. 6 is thereby completed.

According to the secondary battery of this embodiment, the cathode 41 and the anode 42 satisfy the four conditions as the cathode 21 and the anode 22 in the foregoing first embodiment do. Thus, the cycle characteristics, the initial charge and discharge characteristics, and the swollenness characteristics are able to be improved. Other effects of the secondary battery are similar to those of the first embodiment.

### Third Embodiment

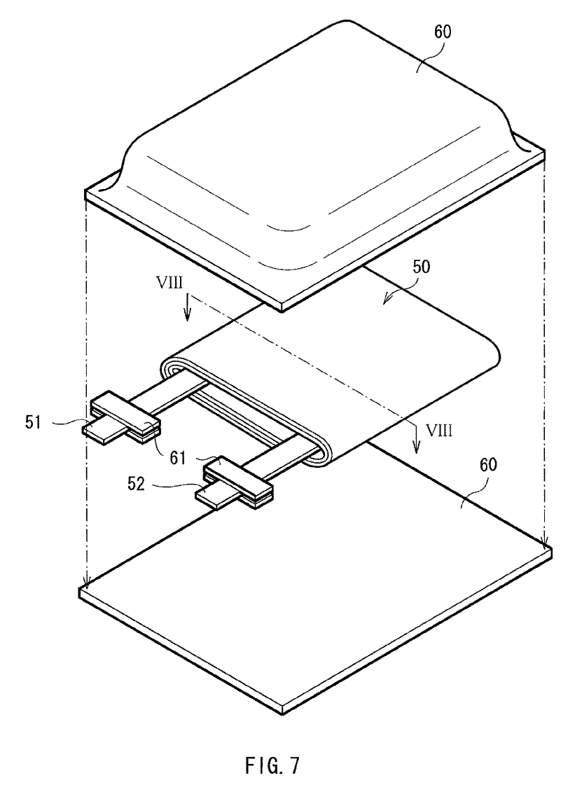

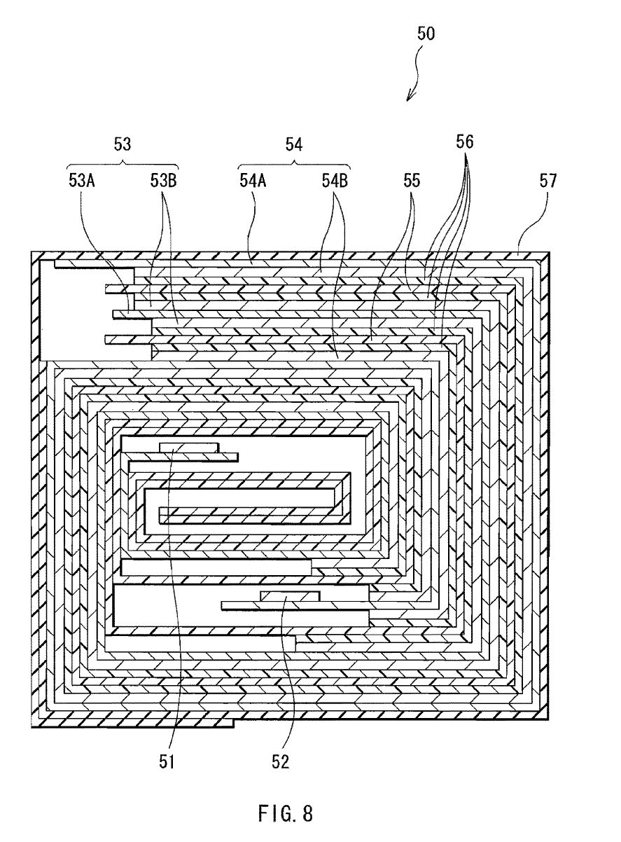

FIG. 7 illustrates an exploded perspective structure of a secondary battery according to a third embodiment of the invention. FIG. 8 illustrates an enlarged cross section taken along line VIII-VIII illustrated in FIG. 7.

The secondary battery is, for example, a lithium ion secondary battery as in the foregoing first embodiment. In the secondary battery, mainly, a spirally wound electrode body 50 on which a cathode lead 51 and an anode lead 52 are attached is contained in a film package member 60. The battery structure using the package member 60 is called the laminated film type.

The cathode lead 51 and the anode lead 52 are respectively derived from inside to outside of the package member 60 in the same direction, for example. However, arrangement positions of the cathode lead 51 and the anode lead 52 with respect to the spirally wound electrode body 50, derivation directions thereof and the like are not particularly limited. The cathode lead 51 is made of, for example, aluminum or the like, and the anode lead 52 is made of, for example, copper, nickel, stainless or the like. These materials are in the shape of, for example, a thin plate or mesh.

The package member 60 is made of a laminated film in which, for example, a fusion bonding layer, a metal layer, and a surface protective layer are layered in this order. In this case, the respective outer edges of two films of the fusion bonding layer are bonded with each other by fusion bonding or an adhesive so that the fusion bonding layer and the spirally wound electrode body 50 are opposed to each other. Examples of fusion bonding layers include a film made of polyethylene, polypropylene or the like. Examples of metal layers include an aluminum foil. Examples of surface protective layers include a film made of nylon, polyethylene terephthalate or the like.

Specially, as the package member 60, an aluminum laminated film in which a polyethylene film, an aluminum foil, and a nylon film are layered in this order is preferable. However, the package member 60 may be made of a laminated film having other laminated structure, a polymer film such as polypropylene, or a metal film, instead of the foregoing aluminum laminated film.

An adhesive film 61 to protect from outside air intrusion is inserted between the package member 60 and the cathode lead 51, the anode lead 52. The adhesive film 61 is made of a material having contact characteristics with respect to the cathode lead 51 and the anode lead 52. Examples of such a material include, for example, a polyolefin resin such as polyethylene, polypropylene, modified polyethylene, and modified polypropylene.

In the spirally wound electrode body 50, a cathode 53 and an anode 54 are layered with a separator 55 and an electrolyte 56 in between and spirally wound. The outermost periphery thereof is protected by a protective tape 57.

The cathode 53 has a structure in which, for example, a cathode active material layer 53B is provided on both faces of a cathode current collector 53A having a pair of faces. The anode 54 has a structure in which, for example, an anode active material layer 54B is provided on both faces of an anode current collector 54A having a pair of faces. The structures of the cathode current collector 53A, the cathode active material layer 53B, the anode current collector 54A, the anode active material layer 54B, and the separator 55 are respectively similar to those of the cathode current collector 21A, the cathode active material layer 21B, the anode current collector 22A, the anode active material layer 22B, and the separator 23 of the foregoing first embodiment.

The electrolyte layer 56 is a so-called gelatinous electrolyte, containing an electrolytic solution and a polymer compound that holds the electrolytic solution. The gelatinous electrolyte is preferable, since high ion conductivity (for example, 1 mS/cm or more at room temperature) is obtained and liquid leakage of the electrolytic solution is prevented.

Examples of polymer compounds include polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethacrylic acid methyl, polyacrylic acid, polymethacrylic acid, styrene-butadiene rubber, nitrile-butadiene rubber, polystyrene, polycarbonate, and a copolymer of vinylidene fluoride and hexafluoro propylene. One of these polymer compounds may be used singly, or two or more thereof may be used by mixture. Specially, polyvinylidene fluoride or the copolymer of vinylidene fluoride and hexafluoro propylene is preferable, since such a polymer compound is electrochemically stable.

The composition of the electrolytic solution is similar to the composition of the electrolytic solution in the foregoing first embodiment. However, in the electrolyte layer 56 as the gelatinous electrolyte, a solvent in the electrolytic solution means a wide concept including not only the liquid solvent but also a solvent having ion conductivity capable of dissociating the electrolyte salt. Therefore, in the case where the polymer compound having ion conductivity is used, the polymer compound is also included in the solvent.

Instead of the gelatinous electrolyte layer 56 in which the electrolytic solution is held by the polymer compound, the electrolytic solution may be directly used. In this case, the electrolytic solution is impregnated in the separator 55.

In the secondary battery, in charge, for example, lithium ions are extracted from the cathode 53, and are inserted in the anode 54 through the electrolyte layer 56. Meanwhile, in discharge, for example, lithium ions are extracted from the anode 54, and are inserted in the cathode 53 through the electrolyte layer 56.

The secondary battery including the gelatinous electrolyte layer 56 is manufactured, for example, by the following three procedures.

In the first manufacturing method, first, for example, the cathode 53 is formed by forming the cathode active material layer 53B on both faces of the cathode current collector 53A, and the anode 54 is formed by forming the anode active material layer 54B on both faces of the anode current collector 54A by a procedure similar to the procedure of forming the cathode 21 and the anode 22 in the foregoing first embodiment. Subsequently, a precursor solution containing an electrolytic solution, a polymer compound, and a solvent is prepared. After the cathode 53 and the anode 54 are coated with the precursor solution, the solvent is volatilized to form the gelatinous electrolyte layer 56. Subsequently, the cathode lead 51 is attached to the cathode current collector 53A by welding or the like, and the anode lead 52 is attached to the anode current collector 54A by welding or the like. Subsequently, the cathode 53 and the anode 54 provided with the electrolyte layer 56 are layered with the separator 55 in between and spirally wound to obtain a laminated body. After that, the protective tape 57 is adhered to the outermost periphery thereof to form the spirally wound electrode body 50. Finally, for example, after the spirally wound electrode body 50 is sandwiched between two pieces of film-like package members 60, outer edges of the package members 60 are contacted by thermal fusion bonding or the like to enclose the spirally wound electrode body 50. At this time, the adhesive films 61 are inserted between the cathode lead 51, the anode lead 52 and the package member 60. Thereby, the secondary battery illustrated in FIG. 7 and FIG. 8 is completed.

In the second manufacturing method, first, the cathode lead 51 is attached to the cathode 53, and the anode lead 52 is attached to the anode 54. Subsequently, the cathode 53 and the anode 54 are layered with the separator 55 in between and spirally wound. After that, the protective tape 57 is adhered to the outermost periphery thereof, and thereby a spirally wound body as a precursor of the spirally wound electrode body 50 is formed. Subsequently, after the spirally wound body is sandwiched between two pieces of the film-like package members 60, the outermost peripheries except for one side are bonded by thermal fusion bonding or the like to obtain a pouched state, and the spirally wound body is contained in the pouch-like package member 60. Subsequently, a composition of matter for electrolyte containing an electrolytic solution, a monomer as a raw material for the polymer compound, a polymerization initiator, and if necessary other material such as a polymerization inhibitor is prepared, which is injected into the pouch-like package member 60. After that, the opening of the package member 60 is hermetically sealed by thermal fusion bonding or the like. Finally, the monomer is thermally polymerized to obtain a polymer compound. Thereby, the gelatinous electrolyte layer 56 is formed. Accordingly, the secondary battery is completed.

In the third manufacturing method, firstly, the spirally wound body is formed and contained in the pouch-like package member 60 in the same manner as that of the foregoing second manufacturing method, except that the separator 55 with both faces coated with a polymer compound is used. Examples of polymer compounds with which the separator 55 is coated include a polymer containing vinylidene fluoride as a component, that is, a homopolymer, a copolymer, and a multicomponent copolymer. Specific examples thereof include polyvinylidene fluoride, a binary copolymer containing vinylidene fluoride and hexafluoro propylene as a component, and a ternary copolymer containing vinylidene fluoride, hexafluoro propylene, and chlorotrifluoroethylene as a component. As a polymer compound, in addition to the foregoing polymer containing vinylidene fluoride as a component, another one or more polymer compounds may be contained. Subsequently, an electrolytic solution is prepared and injected into the package member 60. After that, the opening of the package member 60 is sealed by thermal fusion bonding or the like. Finally, the resultant is heated while a weight is applied to the package member 60, and the separator 55 is contacted with the cathode 53 and the anode 54 with the polymer compound in between. Thereby, the electrolytic solution is impregnated into the polymer compound, and the polymer compound is gelated to form the electrolyte layer 56. Accordingly, the secondary battery is completed.

In the third manufacturing method, the swollenness of the secondary battery is inhibited compared to the first manufacturing method. Further, in the third manufacturing method, the monomer, the solvent and the like as a raw material of the polymer compound are hardly left in the electrolyte layer 56 compared to the second manufacturing method. In addition, the formation step of the polymer compound is favorably controlled. Thus, sufficient contact characteristics are obtained between the cathode 53/the anode 54/the separator 55 and the electrolyte layer 56.

According to the secondary battery of this embodiment, the cathode 53 and the anode 54 satisfy the four conditions as the cathode 21 and the anode 22 in the foregoing first embodiment do. Thus, the cycle characteristics, the initial charge and discharge characteristics, and the swollenness characteristics are able to be improved. Other effects of the secondary battery are similar to those of the first embodiment.

### EXAMPLES

Examples of the invention will be described in detail.

### Examples 1-1 to 1-10

The square secondary battery illustrated in FIG. 1 and FIG. 2 was fabricated by the following procedure. In this case, the secondary battery was formed as a lithium ion secondary battery in which the capacity of the anode 22 was expressed based on insertion and extraction of lithium ions.

First, the cathode 21 was formed by forming the cathode active material layer 21B on the cathode current collector 21A by using coating method. As the cathode current collector 21A, a strip-like aluminum foil (thickness: 15 μm) was used. In forming the cathode active material layer 21B, first, 94 parts by mass of lithium nickel cobalt composite oxide (LiNi_{0.80}Co_{0.20}O₂) as a cathode active material, 5 parts by mass of polyvinylidene fluoride (PVDF) as a cathode binder, and 1 part by mass of Ketjen black as a cathode electrical conductor were mixed to obtain a cathode mixture. Subsequently, the cathode mixture was dispersed in N-methyl-2-pyrrolidone to obtain a paste cathode mixture slurry. Subsequently, both faces of the cathode current collector 21A were uniformly coated with the cathode mixture slurry, which was dried, and thereby the cathode active material layer 21B was formed. Finally, the cathode active material layer 21B was compression-molded by a roll pressing machine.

Next, the anode 22 was formed by forming the anode active material layer 22B on the anode current collector 22A by using evaporation method (electron beam evaporation method). As the anode current collector 22A, an electrolytic copper foil (thickness: 18 μm, arithmetic mean roughness profile Ra: 0.3 μm) was used. In forming the anode active material layer 22B, while oxygen gas and moisture vapor if necessary were continuously introduced into a chamber, silicon as an anode material was deposited on both faces of the anode current collector 22A. Thereby, the plurality of anode active material particles were formed into a single layer structure. In this case, as a polarized electron beam evaporation source, silicon having purity of 99% was used, and the deposition rate was 10 nm/sec. Further, the thickness of the anode active material layer 22B in forming the anode active material layer 22B on a single face side of the anode current collector 22A (formation thickness) was 7 μm, and the oxygen content in the anode active material particles was 3 atomic %.

Next, a liquid electrolyte (electrolytic solution) was prepared. First, as a solvent, ethylene carbonate (EC), propylene carbonate (PC), diethyl carbonate (DEC), and vinylene carbonate (VC) as a cyclic ester carbonate having an unsaturated carbon bond were mixed. After that, as an electrolyte salt, lithium hexafluorophosphate (LiPF₆) was dissolved in the solvent. In this case, the solvent composition (mixture ratio) was EC:PC:DEC:VC=20:10:65:5 at a volume ratio, and the electrolyte salt content to the solvent was 1 mol/kg.

Finally, the secondary battery was assembled by using the cathode 21, the anode 22, and the electrolytic solution. First, the cathode lead 24 made of aluminum was welded to the cathode current collector 21A of the cathode 21, and the anode lead 25 made of nickel was welded to the anode current collector 22A of the anode 22. Subsequently, the cathode 21, the separator 23 made of a polyethylene film (thickness: 18 μm), and the anode 22 were layered in this order and spirally wound. After that, the spirally wound body was shaped into a planular shape to form the battery element 20. Subsequently, the battery element 20 was contained in the battery can 11 made of aluminum After that, the insulating plate 12 was arranged on the battery element 20. Subsequently, the cathode lead 24 was welded to the cathode pin 15, and the anode lead 25 was welded to the battery can 11. Subsequently, the battery cover 13 was laser-welded to the open end section of the battery can 11. Finally, an electrolytic solution was injected into the battery can 11 through the injection hole 19. After that, the injection hole 19 was sealed by the sealing member 19A, and thereby a square type secondary battery was completed.

In fabricating the secondary battery, by adjusting the thickness of the cathode active material layer 21B, lithium metal was prevented from being precipitated on the anode 22 in a fully charged state. Specifically, the usage ratio in the fully charged state of the anode 22 was changed as illustrated in Table 1. The procedure and the condition in calculating the usage ratio are the same as those described in the foregoing first embodiment.

### Examples 2-1 to 2-10

A procedure similar to that of Examples 1-1 to 1-10 was executed, except that lithium nickel cobalt manganese composite oxide (LiNi_{0.80}Co_{0.10}Mn_{0.10}O₂) was used as a cathode active material.

### Examples 3-1 to 3-10

A procedure similar to that of Examples 1-1 to 1-10 was executed, except that lithium nickel cobalt aluminum composite oxide (LiNi_{0.79}Cu_{0.14}Al_{0.07}O₂) was used as a cathode active material.

### Examples 4-1 to 4-10

A procedure similar to that of Examples 1-1 to 1-10 was executed, except that lithium nickel cobalt aluminum barium composite oxide (LiNi_{0.76}Co_{0.20}Al_{0.03}Ba_{0.01}O₂) was used as a cathode active material.

### Examples 5-1 to 5-10

A procedure similar to that of Examples 1-1 to 1-10 was executed, except that lithium nickel cobalt aluminum iron composite oxide (LiNi_{0.80}Co_{0.10}Al_{0.06}Fe_{0.04}O₂) was used as a cathode active material.

### Examples 6-1 to 6-10

A procedure similar to that of Examples 1-1 to 1-10 was executed, except that lithium nickel composite oxide (LiNiO₂) was used as a cathode active material.

### Examples 7-1 to 7-10

A procedure similar to that of Examples 1-1 to 1-10 was executed, except that lithium cobalt composite oxide (LiCoO₂) was used as a cathode active material.

### Examples 8-1 to 8-10

A procedure similar to that of Examples 1-1 to 1-10 was executed, except that lithium manganese composite oxide (LiMn₂O₂) was used as a cathode active material.

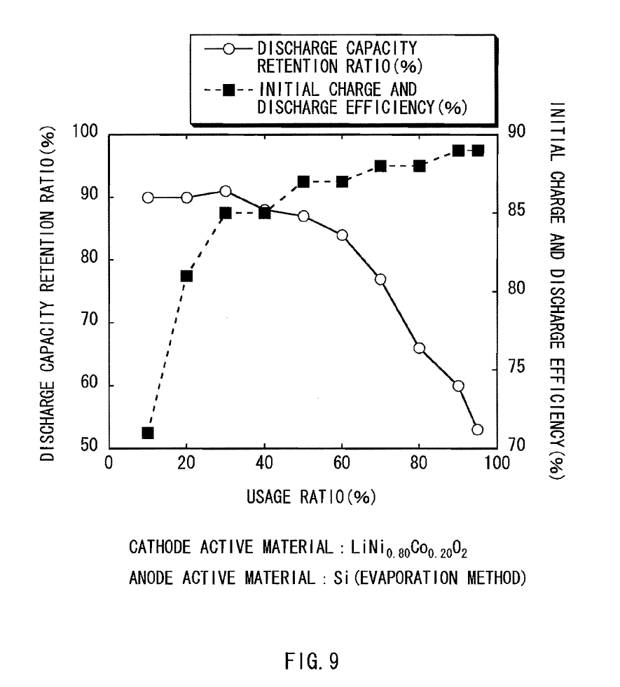

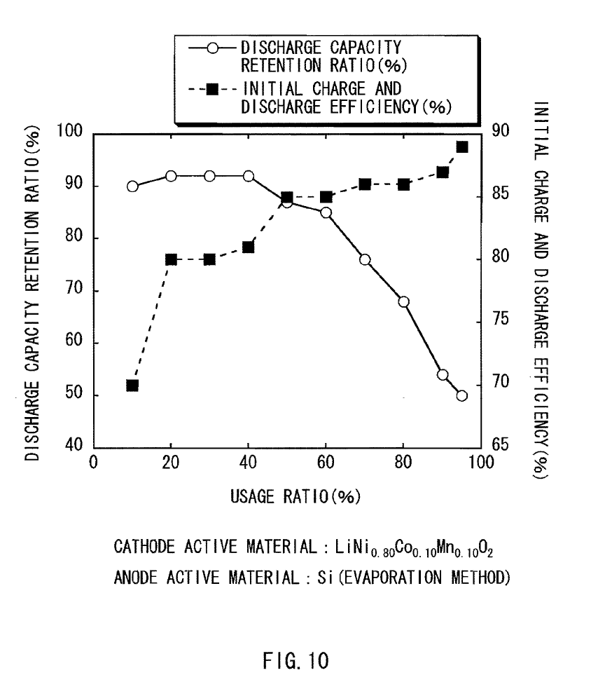

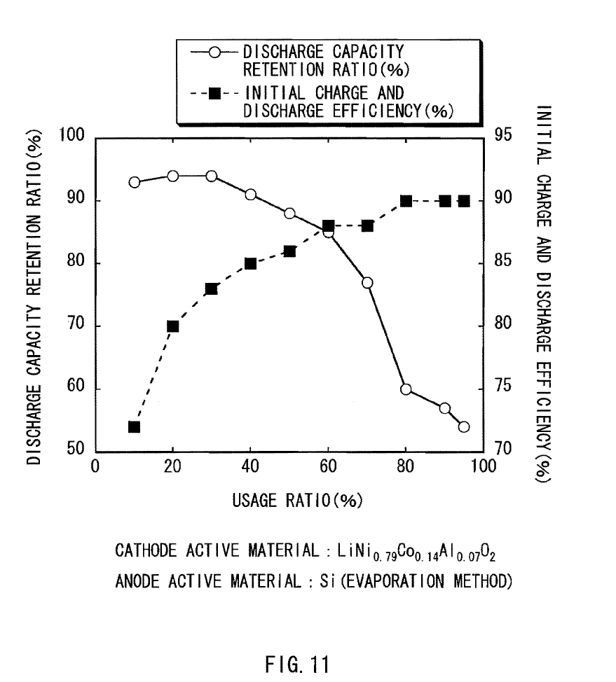

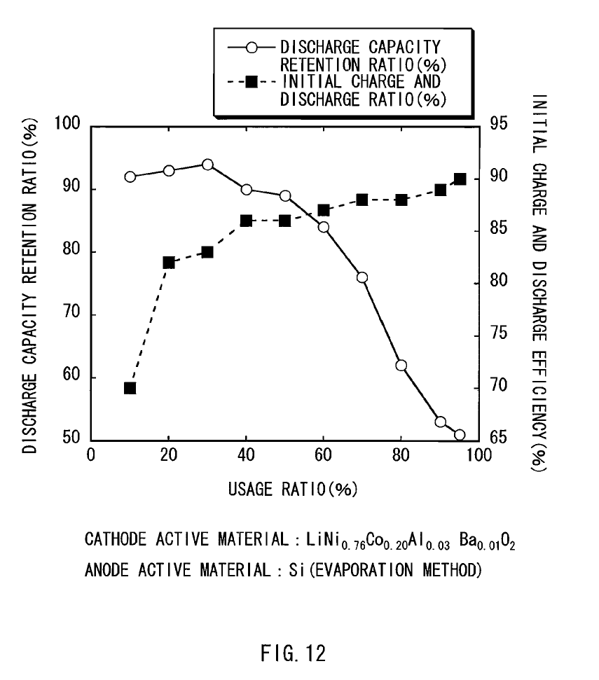

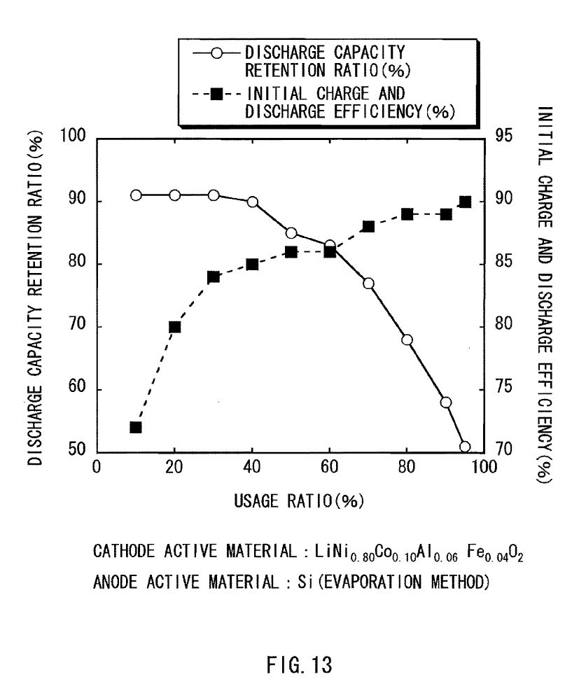

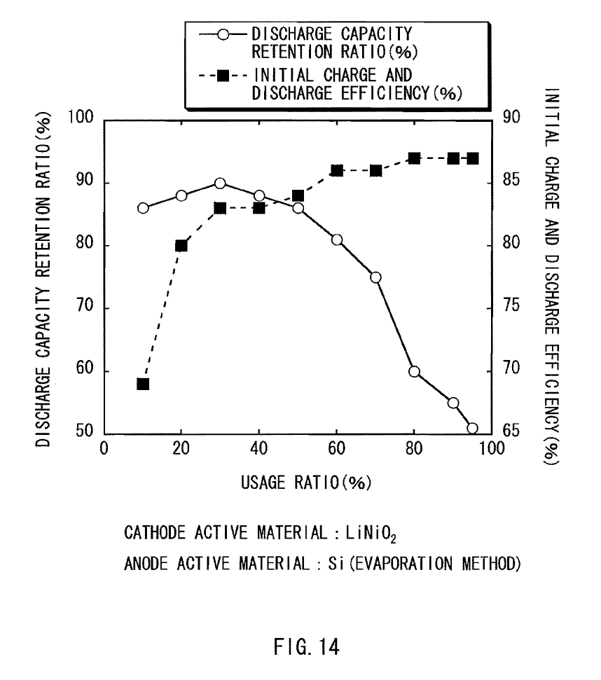

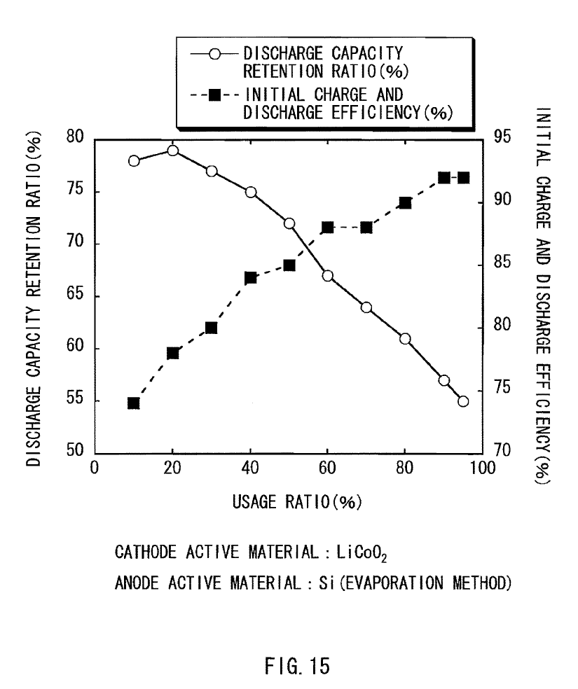

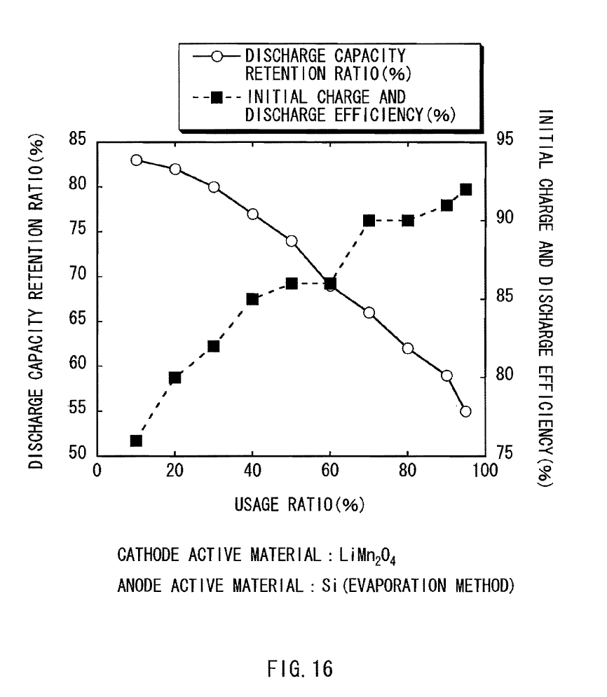

For the secondary batteries of Examples 1-1 to 1-10 to Examples 8-1 to 8-10, the cycle characteristics, the initial charge and discharge characteristics, and the swollenness characteristics were examined. The results illustrated in Table 1 to Table 8 and FIG. 9 to FIG. 16 were obtained.

In examining the cycle characteristics, a cycle test was performed and thereby the discharge capacity retention ratio was obtained. First, to stabilize the battery state, after charge and discharge were performed 1 cycle in the atmosphere at 23 deg C., charge and discharge were performed again to measure the discharge capacity at the second cycle. Subsequently, charge and discharge were performed 99 cycles in the same atmosphere to measure the discharge capacity at the 101st cycle. Finally, the discharge capacity retention ratio (%)=(discharge capacity at the 101st cycle/discharge capacity at the second cycle)*100 was calculated. In this case, for charge conditions, after charge was performed at the constant current density of 3 mA/cm² until the battery voltage reached 4.2 V, charge was continuously performed at the constant voltage of 4.2 V until the current density reached 0.3 mA/cm². Further, for discharge conditions, discharge was performed at the constant current density of 3 mA/cm² until the battery voltage reached 2.7 V.

For examining the initial charge and discharge characteristics, after the charge capacity and the discharge capacity at the second cycle in the foregoing cycle test were measured, the initial charge and discharge efficiency (%)=(discharge capacity at the second cycle/charge capacity at the second cycle)*100 was calculated.

For examining the swollenness characteristics, the thickness after discharge at the second cycle and the thickness after discharge at the 101st cycle in the foregoing cycle test were measured. After that, the swollenness ratio (%)=[(thickness after discharge at the 101st cycle—thickness after discharge at the second cycle)/thickness after discharge at the second cycle]*100 was calculated.

The thicknesses of the anode active material layer 22B in the initial charge and discharge (initial charge and discharge thickness) illustrated in Table 1 to Table 8 are thicknesses measured after charge and discharge (in discharged state) at the third cycle in the foregoing cycle test.

TABLE 1

| | | Anode | | | | | | | |
|---|---|---|---|---|---|---|---|---|---|
| | | | Anode active material layer | | | | | Initial | |
| | | | | | Initial charge | | | charge | |
| | | | | | and | | Discharge | and | |
| | Cathode | | | Formation | discharge | | capacity | discharge | Swollenness |
| | Cathode active | Anode active | Usage ratio | thickness | thickness | Formation | retention ratio | efficiency | ratio |
| | material | material | (%) | (μm) | (μm) | method | (%) | (%) | (%) |
| Example 1-1 | LiNi_{0.80}Co_{0.20}O₂ | Si | 20 | 7 | 12 | Evaporation | 90 | 81 | — |
| Example 1-2 | | (containing O₂) | 30 | | | method | 91 | 85 | — |
| Example 1-3 | | | 40 | | | | 88 | 85 | 10 |
| Example 1-4 | | | 50 | | | | 87 | 87 | — |
| Example 1-5 | | | 60 | | | | 84 | 87 | — |
| Example 1-6 | | | 70 | | | | 77 | 88 | — |
| Example 1-7 | LiNi_{0.80}Co_{0.20}O₂ | Si | 10 | 7 | 12 | Evaporation | 90 | 71 | — |
| Example 1-8 | | (containing O₂) | 80 | | | method | 66 | 88 | — |
| Example 1-9 | | | 90 | | | | 60 | 89 | 24 |
| Example 1-10 | | | 95 | | | | 53 | 89 | — |

TABLE 2

| | | Anode | | | | | | | |
|---|---|---|---|---|---|---|---|---|---|
| | | | Anode active material layer | | | | | Initial | |
| | | | | | Initial charge | | Discharge | charge | |
| | | | | | and | | capacity | and | |
| | Cathode | | Usage | Formation | discharge | | retention | discharge | Swollenness |
| | Cathode active | Anode active | ratio | thickness | thickness | Formation | ratio | efficiency | ratio |
| | material | material | (%) | (μm) | (μm) | method | (%) | (%) | (%) |
| Example 2-1 | LiNi_{0.80}Co_{0.10}Mn_{0.10}O₂ | Si | 20 | 7 | 12 | Evaporation | 92 | 80 | — |
| Example 2-2 | | (containing O₂) | 30 | | | method | 92 | 80 | — |
| Example 2-3 | | | 40 | | | | 92 | 81 | 8 |
| Example 2-4 | | | 50 | | | | 87 | 85 | — |
| Example 2-5 | | | 60 | | | | 85 | 85 | — |
| Example 2-6 | | | 70 | | | | 76 | 86 | — |
| Example 2-7 | LiNi_{0.80}Co_{0.10}Mn_{0.10}O₂ | Si | 10 | 7 | 12 | Evaporation | 90 | 70 | — |
| Example 2-8 | | (containing O₂) | 80 | | | method | 68 | 86 | — |
| Example 2-9 | | | 90 | | | | 54 | 87 | 25 |
| Example 2-10 | | | 95 | | | | 50 | 89 | — |

TABLE 3

| | | Anode | | | | | | | |
|---|---|---|---|---|---|---|---|---|---|
| | | | Anode active material layer | | | | | Initial | |
| | | | | Forma- | Initial charge | | Discharge | charge | |
| | | | | tion | and | | capacity | and | Swollen- |
| | Cathode | Anode | Usage | thick- | discharge | | retention | discharge | ness |
| | Cathode active | active | ratio | ness | thickness | Formation | ratio | efficiency | ratio |
| | material | material | (%) | (μm) | (μm) | method | (%) | (%) | (%) |
| Example 3-1 | LiNi_{0.79}Co_{0.14}Al_{0.07}O₂ | Si | 20 | 7 | 12 | Evaporation | 94 | 80 | — |
| Example 3-2 | | (contain- | 30 | | | method | 94 | 83 | — |
| | | ing O₂) | | | | | | | |
| Example 3-3 | | | 40 | | | | 91 | 85 | 5 |
| Example 3-4 | | | 50 | | | | 88 | 86 | — |
| Example 3-5 | | | 60 | | | | 85 | 88 | — |
| Example 3-6 | | | 70 | | | | 77 | 88 | — |
| Example 3-7 | LiNi_{0.79}Co_{0.14}Al_{0.07}O₂ | Si | 10 | 7 | 12 | Evaporation | 93 | 72 | — |
| Example 3-8 | | (contain- | 80 | | | method | 60 | 90 | — |
| | | ing O₂) | | | | | | | |
| Example 3-9 | | | 90 | | | | 57 | 90 | 23 |
| Example 3-10 | | | 95 | | | | 54 | 90 | — |

TABLE 4

| | | Anode | | | | | | | |
|---|---|---|---|---|---|---|---|---|---|
| | | | Anode active material layer | | | | | Initial | |
| | | | | Forma- | Initial charge | | Discharge | charge | |
| | | | | tion | and | | capacity | and | Swollen- |
| | Cathode | Anode | Usage | thick- | discharge | | retention | discharge | ness |
| | Cathode active | active | ratio | ness | thickness | Formation | ratio | efficiency | ratio |
| | material | material | (%) | (μm) | (μm) | method | (%) | (%) | (%) |
| Example 4-1 | LiNi_{0.76}Co_{0.20}Al_{0.03}Ba_{0.01}O₂ | Si | 20 | 7 | 12 | Evaporation | 93 | 82 | — |
| Example 4-2 | | (contain- | 30 | | | method | 94 | 83 | — |
| | | ing O₂) | | | | | | | |
| Example 4-3 | | | 40 | | | | 90 | 86 | 7 |
| Example 4-4 | | | 50 | | | | 89 | 86 | — |
| Example 4-5 | | | 60 | | | | 84 | 87 | — |
| Example 4-6 | | | 70 | | | | 76 | 88 | — |
| Example 4-7 | LiNi_{0.76}Co_{0.20}Al_{0.03}Ba_{0.01}O₂ | Si | 10 | 7 | 12 | Evaporation | 92 | 70 | — |
| Example 4-8 | | (contain- | 80 | | | method | 62 | 88 | — |
| | | ing O₂) | | | | | | | |
| Example 4-9 | | | 90 | | | | 53 | 89 | 28 |
| Example 4- | | | 95 | | | | 51 | 90 | — |
| 10 | | | | | | | | | |

TABLE 5

| | | Anode | | | | | | | |
|---|---|---|---|---|---|---|---|---|---|
| | | | Anode active material layer | | | | | Initial | |
| | | | | Forma- | Initial charge | | Discharge | charge | |
| | | | | tion | and | | capacity | and | Swollen- |
| | Cathode | Anode | Usage | thick- | discharge | | retention | discharge | ness |
| | Cathode active | active | ratio | ness | thickness | Formation | ratio | efficiency | ratio |
| | material | material | (%) | (μm) | (μm) | method | (%) | (%) | (%) |
| Example 5-1 | LiNi_{0.80}Co_{0.10}Al_{0.06}Fe_{0.04}O₂ | Si | 20 | 7 | 12 | Evaporation | 91 | 80 | — |
| Example 5-2 | | (contain- | 30 | | | method | 91 | 84 | — |
| | | ing O₂) | | | | | | | |
| Example 5-3 | | | 40 | | | | 90 | 85 | 9 |
| Example 5-4 | | | 50 | | | | 85 | 86 | — |
| Example 5-5 | | | 60 | | | | 83 | 86 | — |
| Example 5-6 | | | 70 | | | | 77 | 88 | — |
| Example 5-7 | LiNi_{0.80}Co_{0.10}Al_{0.06}Fe_{0.04}O₂ | Si | 10 | 7 | 12 | Evaporation | 91 | 72 | — |
| Example 5-8 | | (contain- | 80 | | | method | 68 | 89 | — |
| | | ing O₂) | | | | | | | |
| Example 5-9 | | | 90 | | | | 58 | 89 | 26 |
| Example 5- | | | 95 | | | | 51 | 90 | — |
| 10 | | | | | | | | | |

TABLE 6

| | | Anode | | | | | | | |
|---|---|---|---|---|---|---|---|---|---|
| | | | Anode active material layer | | | | | Initial | |
| | | | | | Initial charge | | Discharge | charge | |
| | | | | | and | | capacity | and | |
| | Cathode | | Usage | Formation | discharge | | retention | discharge | Swollenness |
| | Cathode active | Anode active | ratio | thickness | thickness | Formation | ratio | efficiency | ratio |
| | material | material | (%) | (μm) | (μm) | method | (%) | (%) | (%) |
| Example 6-1 | LiNiO₂ | Si | 10 | 7 | 12 | Evaporation | 86 | 69 | — |
| Example 6-2 | | (containing O₂) | 20 | | | method | 88 | 80 | — |
| Example 6-3 | | | 30 | | | | 90 | 83 | — |
| Example 6-4 | | | 40 | | | | 88 | 83 | 12 |
| Example 6-5 | | | 50 | | | | 86 | 84 | — |
| Example 6-6 | | | 60 | | | | 81 | 86 | — |
| Example 6-7 | | | 70 | | | | 75 | 86 | — |
| Example 6-8 | | | 80 | | | | 60 | 87 | — |
| Example 6-9 | | | 90 | | | | 55 | 87 | 26 |
| Example 6-10 | | | 95 | | | | 51 | 87 | — |

TABLE 7

| | | Anode | | | | | | | |
|---|---|---|---|---|---|---|---|---|---|
| | | | Anode active material layer | | | | Discharge | Initial | |
| | Cathode | | | | Initial charge | | capacity | charge and | Swollen- |
| | Cathode | | Usage | Formation | and discharge | | retention | discharge | ness |
| | active | Anode active | ratio | thickness | thickness | Formation | ratio | efficiency | ratio |
| | material | material | (%) | (μm) | (μm) | method | (%) | (%) | (%) |
| Example 7-1 | LiCoO₂ | Si | 10 | 7 | 12 | Evaporation | 78 | 74 | — |
| Example 7-2 | | (containing O₂) | 20 | | | method | 79 | 78 | — |
| Example 7-3 | | | 30 | | | | 77 | 80 | — |
| Example 7-4 | | | 40 | | | | 75 | 84 | 28 |
| Example 7-5 | | | 50 | | | | 72 | 85 | — |
| Example 7-6 | | | 60 | | | | 67 | 88 | — |
| Example 7-7 | | | 70 | | | | 64 | 88 | — |
| Example 7-8 | | | 80 | | | | 61 | 90 | — |
| Example 7-9 | | | 90 | | | | 57 | 92 | 24 |
| Example 7-10 | | | 95 | | | | 55 | 92 | — |

TABLE 8

| | | Anode | | | | | | | |
|---|---|---|---|---|---|---|---|---|---|
| | | | Anode active material layer | | | | Discharge | Initial | |
| | Cathode | | | | Initial charge | | capacity | charge and | Swollen- |
| | Cathode | | Usage | Formation | and discharge | | retention | discharge | ness |
| | active | Anode active | ratio | thickness | thickness | Formation | ratio | efficiency | ratio |
| | material | material | (%) | (μm) | (μm) | method | (%) | (%) | (%) |
| Example 8-1 | LiMn₂O₄ | Si | 10 | 7 | 12 | Evaporation | 83 | 76 | — |
| Example 8-2 | | (containing O₂) | 20 | | | method | 82 | 80 | — |
| Example 8-3 | | | 30 | | | | 80 | 82 | — |
| Example 8-4 | | | 40 | | | | 77 | 85 | 22 |
| Example 8-5 | | | 50 | | | | 74 | 86 | — |
| Example 8-6 | | | 60 | | | | 69 | 86 | — |
| Example 8-7 | | | 70 | | | | 66 | 90 | — |
| Example 8-8 | | | 80 | | | | 62 | 90 | — |
| Example 8-9 | | | 90 | | | | 59 | 91 | 21 |
| Example 8-10 | | | 95 | | | | 55 | 92 | — |

As illustrated in Table 1 to Table 8 and FIG. 9 to FIG. 16, in the case where the cathode active material layer 21B contained the lithium-nickel based composite oxide as a cathode active material and the usage ratio of the anode 22 was from 20% to 70% both inclusive, favorable results were obtained compared to the case that these conditions were not satisfied.

More specifically, in Examples 1-1 to 1-10 in which the lithium-nickel based composite oxide (LiNi_{0.80}Co_{0.20}O₂) was used, the discharge capacity retention ratio and the initial charge and discharge efficiency were higher compared to in Examples 6-1 to 6-10 to 8-1 to 8-10 in which the composite oxide not applicable thereto (LiNiO₂ and the like) was used.

Further, in Examples 1-1 to 1-10 in which LiNi_{0.80}Co_{0.20}O₂ was used, in the case where the usage ratio was from 20% to 70% both inclusive, both the discharge capacity retention ratio and the initial charge and discharge efficiency were higher compared to the case that the usage ratio was out of the foregoing range.

Further, in Examples 1-1 to 1-10 in which LiNi_{0.80}CO_{0.20}O₂ was used, in the case where the usage ratio was 40%, the swollenness ratio was smaller compared to the case that the usage ratio was 90%. Meanwhile, in Examples 6-1 to 6-10 to 8-1 to 8-10 in which LiNiO₂ or the like was used, in the case where the usage ratio was 40%, the swollenness ratio was easily increased compared to the case that the usage ratio was 90%.

The foregoing tendency for Examples 1-1 to 1-10 and Examples 6-1 to 6-10 to 8-1 to 8-10 is similarly shown in Examples 2-1 to 2-6 to Examples 5-1 to 5-6 in which LiNi_{0.80}Co_{0.10}Mn_{0.10}O₂ or the like was used.

Accordingly, in the secondary battery of the invention, by using the lithium-nickel based composite oxide as a cathode active material and using silicon as an anode active material, the cycle characteristics, the initial charge and discharge characteristics, and the swollenness characteristics were improved. In this case, in the case where the usage ratio of the anode 22 was from 20% to 70% both inclusive, the foregoing respective characteristics were more improved.

### Examples 9-1 to 9-10

A procedure similar to that of Examples 3-1 to 3-10 was executed, except that the oxygen content in the anode active material particles was increased to 6 atomic % (increase of O₂) by adjusting the amount of oxygen gas or the like introduced into a chamber.

### Examples 10-1 to 10-10

A procedure similar to that of Examples 3-1 to 3-10 was executed, except that silicon was deposited 10 times while oxygen gas or the like was intermittently introduced into a chamber, and thereby the anode active material particles were formed into a multilayer structure alternately having a high oxygen-containing region and a low oxygen-containing region (containing striped O₂). In this case, the deposition thickness of silicon per single deposition was 0.7 μm and the oxygen content in the whole anode active material was 6 atomic %.

### Examples 11-1 to 11-10

A procedure similar to that of Examples 10-1 to 10-10 was executed, except that after the plurality of anode active material particles were formed, a nickel plated film was formed as a metal material by using electrolytic plating method. In forming the metal material, a current was applied while air was supplied to a plating bath, and thereby the nickel plated film was grown on the both faces of the anode current collector 22A on which the anode active material particles were formed. In this case, as a plating solution, a nickel plating solution, Nippon Kojundo Kagaku Co., Ltd. make was used. The current density was from 2 A/dm² to 10 A/dm² both inclusive, the growth rate of the plating film was 10 nm/sec, and the content of the metal material in the anode active material layer 22B was 5 atomic %.

### Examples 12-1 to 12-10

A procedure similar to that of Examples 1-1 to 1-10 was executed, except that the anode active material layer 22B was formed by using coating method. In forming the anode active material layer 22B, first, 85 parts by mass of crystalline silicon (median diameter: 4 μm) as an anode active material, 12 parts by mass of PVDF as an anode binder, and 3 parts by mass of VGCF as an anode electrical conductor were mixed to obtain an anode mixture. Subsequently, the anode mixture was dispersed in N-methyl-2-pyrrolidone to obtain a paste anode mixture slurry. Subsequently, both faces of the anode current collector 22A were uniformly coated with the anode mixture slurry and the resultant was dried, and thereby the anode active material layer 22B was formed. After that, the anode active material layer 22B was compression-molded by using a rolling press machine. Finally, the anode active material layer 22B was provided with heat treatment in argon (Ar) gas atmosphere under conditions at 220 deg C. for 12 hours.

### Examples 13-1 to 13-10

A procedure similar to that of Examples 1-1 to 1-10 was executed, except that the anode active material layer 22B was formed by using coating method. In forming the anode active material layer 22B, first, 80 parts by mass of crystalline silicon (median diameter: 4 μm) as an anode active material, 12 parts by mass of thermoplastic polyimide (PI) and 5 parts by mass of PVDF as an anode binder, and 3 parts by mass of VGCF as an anode electrical conductor were mixed to obtain an anode mixture. Subsequently, the anode mixture was dispersed in N-methyl-2-pyrrolidone to obtain a paste anode mixture slurry. Subsequently, both faces of the anode current collector 22A were uniformly coated with the anode mixture slurry and the resultant was dried, and thereby the anode active material layer 22B was formed. After that, the anode active material layer 22B was compression-molded by using a rolling press machine. Finally, the anode active material layer 22B was provided with heat treatment in argon gas atmosphere under conditions at 650 deg C. for 3 hours.

### Examples 14-1 to 14-10

A procedure similar to that of Examples 1-1 to 1-10 was executed, except that the anode active material layer 22B was formed by using spraying method (gas frame spraying method). In forming the anode active material layer 22B, both faces of the anode current collector 22A were sprayed with silicon powder in a molten state or a semi-molten state, and thereby the plurality of anode active material particles were formed. In this case, spraying treatment was provided at the spraying rate of about from 45 m/sec to 55 m/sec both inclusive, while cooling a platform with carbon dioxide to prevent the anode current collector 22A from getting thermal damage.

For the secondary batteries of Examples 9-1 to 9-10 to Examples 14-1 to 14-10, the cycle characteristics were examined. The results illustrated in Table 9 to Table 14 were obtained.

TABLE 9

| | | Anode | | | | | |
|---|---|---|---|---|---|---|---|
| | | | Anode active material layer | | | | |
| | | | | | Initial | | Discharge |
| | | | | | charge and | | capacity |
| | Cathode | Anode | Usage | Formation | discharge | | retention |
| | Cathode active | active | ratio | thickness | thickness | Formation | ratio |
| | material | material | (%) | (μm) | (μm) | method | (%) |
| Example 9-1 | LiNi_{0.79}Co_{0.14}Al_{0.07}O₂ | Si | 20 | 7 | 12 | Evaporation | 94 |
| Example 9-2 | | (increase | 30 | | | method | 96 |
| Example 9-3 | | of O₂) | 40 | | | | 93 |
| Example 9-4 | | | 50 | | | | 90 |
| Example 9-5 | | | 60 | | | | 87 |
| Example 9-6 | | | 70 | | | | 79 |
| Example 9-7 | LiNi_{0.79}Co_{0.14}Al_{0.07}O₂ | Si | 10 | 7 | 12 | Evaporation | 94 |
| Example 9-8 | | (increase | 80 | | | method | 65 |
| Example 9-9 | | of O₂) | 90 | | | | 60 |
| Example 9-10 | | | 95 | | | | 58 |

TABLE 10

| | | Anode | | | | | |
|---|---|---|---|---|---|---|---|
| | | | Anode active material layer | | | | |
| | | | | | Initial | | Discharge |
| | | | | | charge and | | capacity |
| | Cathode | Anode | Usage | Formation | discharge | | retention |
| | Cathode active | active | ratio | thickness | thickness | Formation | ratio |
| | material | material | (%) | (μm) | (μm) | method | (%) |
| Example 10-1 | LiNi_{0.79}Co_{0.14}Al_{0.07}O₂ | Si | 20 | 7 | 12 | Evaporation | 94 |
| Example 10-2 | | (containing | 30 | | | method | 97 |
| Example 10-3 | | striped O₂) | 40 | | | | 95 |
| Example 10-4 | | | 50 | | | | 94 |
| Example 10-5 | | | 60 | | | | 91 |
| Example 10-6 | | | 70 | | | | 85 |
| Example 10-7 | LiNi_{0.79}Co_{0.14}Al_{0.07}O₂ | Si | 10 | 7 | 12 | Evaporation | 94 |
| Example 10-8 | | (containing | 80 | | | method | 79 |
| Example 10-9 | | striped O₂) | 90 | | | | 72 |
| Example 10-10 | | | 95 | | | | 69 |

TABLE 11

| | | Anode | | | | | | |
|---|---|---|---|---|---|---|---|---|
| | | | | Anode active material layer | | | | Discharge |
| | | | | | | Initial charge | | capacity |
| | Cathode | | | Usage | Formation | and discharge | | retention |
| | Cathode active | Anode active | Metal | ratio | thickness | thickness | Formation | ratio |
| | material | material | material | (%) | (μm) | (μm) | method | (%) |
| Example 11-1 | LiNi_{0.79}Co_{0.14}Al_{0.07}O₂ | Si | Ni | 20 | 7 | 12 | Evaporation | 95 |
| Example 11-2 | | (containing | | 30 | | | method | 96 |
| Example 11-3 | | striped O₂) | | 40 | | | | 96 |
| Example 11-4 | | | | 50 | | | | 95 |
| Example 11-5 | | | | 60 | | | | 93 |
| Example 11-6 | | | | 70 | | | | 90 |
| Example 11-7 | LiNi_{0.79}Co_{0.14}Al_{0.07}O₂ | Si | Ni | 10 | 7 | 12 | Evaporation | 95 |
| Example 11-8 | | (containing | | 80 | | | method | 84 |
| Example 11-9 | | striped O₂) | | 90 | | | | 80 |
| Example 11-10 | | | | 95 | | | | 78 |

TABLE 12

| | | Anode | | | | | |
|---|---|---|---|---|---|---|---|
| | | | Anode active material layer | | | | Discharge |
| | | | | | Initial charge | | capacity |
| | Cathode | | Usage | Formation | and discharge | | retention |
| | Cathode active | Anode active | ratio | thickness | thickness | Formation | ratio |
| | material | material | (%) | (μm) | (μm) | method | (%) |
| Example 12-1 | LiNi_{0.79}Co_{0.14}Al_{0.07}O₂ | Si | 20 | 7 | 12 | Coating | 87 |
| Example 12-2 | | (containing | 30 | | | method | 82 |
| Example 12-3 | | O₂) | 40 | | | (anode binder: | 80 |
| Example 12-4 | | | 50 | | | PVDF) | 77 |
| Example 12-5 | | | 60 | | | | 75 |
| Example 12-6 | | | 70 | | | | 65 |
| Example 12-7 | LiNi_{0.79}Co_{0.14}Al_{0.07}O₂ | Si | 10 | 7 | 12 | Coating | 85 |
| Example 12-8 | | (containing | 80 | | | method | 56 |
| Example 12-9 | | O₂) | 90 | | | (anode binder: | 49 |
| Example 12-10 | | | 95 | | | PVDF) | 45 |

TABLE 13

| | | Anode | | | | | |
|---|---|---|---|---|---|---|---|
| | | | Anode active material layer | | | | Discharge |
| | | | | | Initial charge | | capacity |
| | Cathode | | Usage | Formation | and discharge | | retention |
| | Cathode active | Anode active | ratio | thickness | thickness | Formation | ratio |
| | material | material | (%) | (μm) | (μm) | method | (%) |
| Example 13-1 | LiNi_{0.79}Co_{0.14}Al_{0.07}O₂ | Si | 20 | 7 | 12 | Coating | 86 |
| Example 13-2 | | (containing | 30 | | | method | 84 |
| Example 13-3 | | O₂) | 40 | | | (anode binder: | 81 |
| Example 13-4 | | | 50 | | | PI) | 79 |
| Example 13-5 | | | 60 | | | | 77 |
| Example 13-6 | | | 70 | | | | 70 |
| Example 13-7 | LiNi_{0.79}Co_{0.14}Al_{0.07}O₂ | Si | 10 | 7 | 12 | Coating | 86 |
| Example 13-8 | | (containing | 80 | | | method | 56 |
| Example 13-9 | | O₂) | 90 | | | (anode binder: | 51 |
| Example 13-10 | | | 95 | | | PI) | 44 |

TABLE 14

| | | Anode | | | | | |
|---|---|---|---|---|---|---|---|
| | | | Anode active material layer | | | | Discharge |
| | | | | | Initial charge | | capacity |
| | Cathode | | Usage | Formation | and discharge | | retention |
| | Cathode active | Anode active | ratio | thickness | thickness | Formation | ratio |
| | material | material | (%) | (μm) | (μm) | method | (%) |
| Example 14-1 | LiNi_{0.79}Co_{0.14}Al_{0.07}O₂ | Si | 20 | 7 | 12 | Spraying | 95 |
| Example 14-2 | | (containing | 30 | | | method | 95 |
| Example 14-3 | | O₂) | 40 | | | | 94 |
| Example 14-4 | | | 50 | | | | 92 |
| Example 14-5 | | | 60 | | | | 89 |
| Example 14-6 | | | 70 | | | | 87 |
| Example 14-7 | LiNi_{0.79}Co_{0.14}Al_{0.07}O₂ | Si | 10 | 7 | 12 | Spraying | 95 |
| Example 14-8 | | (containing | 80 | | | method | 84 |
| Example 14-9 | | O₂) | 90 | | | | 79 |
| Example 14-10 | | | 95 | | | | 71 |

As illustrated in Table 9 to Table 14, in the case where the formation method of the anode active material layer 22B was changed, results similar to those of Table 3 were obtained. That is, in Examples 9-1 to 9-10 to Examples 14-1 to 14-10, in the case where the usage ratio of the anode 22 was from 20% to 70% both inclusive, the discharge capacity retention ratio was higher compared to the case that the usage ratio of the anode 22 was out of the foregoing range.

In particular, in the case of using evaporation method or spraying method as a formation method of the anode active material layer 22B, the discharge capacity retention ratio tended to be higher compared to the case of using coating method. Further, in the case of increasing the oxygen content in the anode active material particles, introducing the high oxygen-containing region and the low oxygen-containing region into the anode active material particles, or forming the metal material, the discharge capacity retention ratio tended to be even higher.

Accordingly, in the secondary battery of the invention, in the case where the formation method of the anode active material layer 22B was changed, the cycle characteristics were improved as well.

### Examples 15-1 to 15-7, 16-1 to 16-7, and 17-1 to 17-6

A procedure similar to that of Examples 3-3, 7-4, and 14-3 was executed, except that the formation thickness and the initial charge and discharge thickness of the anode active material layer 22B were changed as illustrated in Table 15 to Table 17.

### Examples 18-1 to 18-7

A procedure similar to that of Examples 16-1 to 16-7 was executed, except that spraying method was used as a formation method of the anode active material layer 22B, and the formation thickness and the initial charge and discharge thickness thereof were changed as illustrated in Table 18.

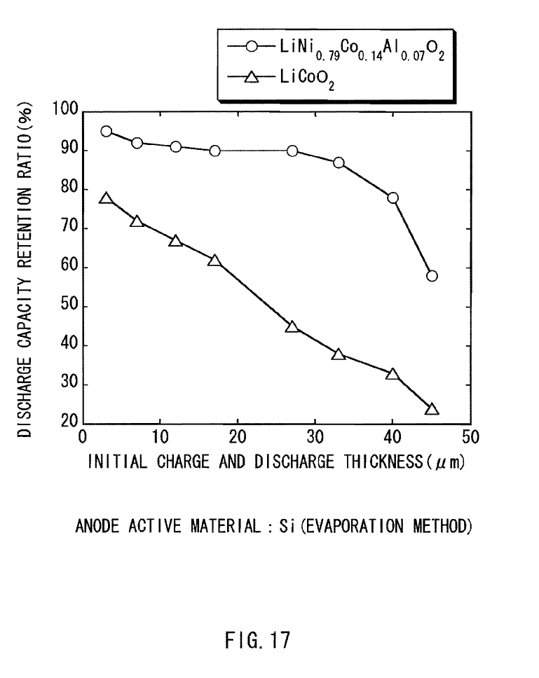

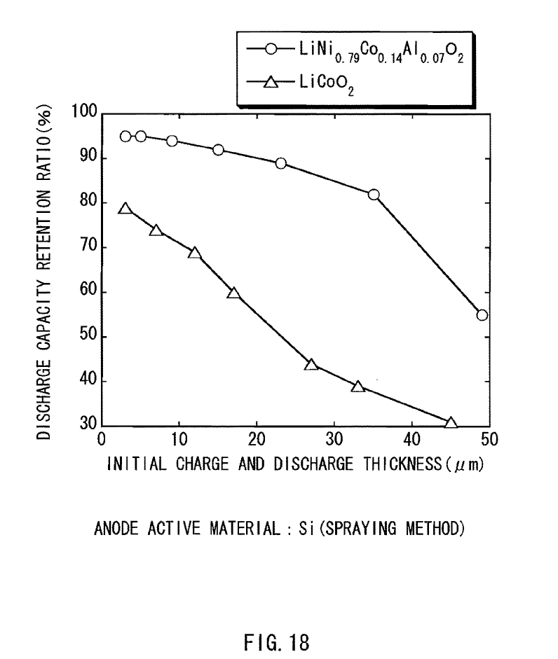

For the secondary batteries of Examples 15-1 to 15-7 to Examples 18-1 to 18-7, the cycle characteristics were examined. The results illustrated in Table 15 to Table 18, FIG. 17, and FIG. 18 were obtained.

TABLE 15

| | | Anode | | | | | |
|---|---|---|---|---|---|---|---|
| | | | Anode active material layer | | | | Discharge |
| | | | | | Initial charge | | capacity |
| | Cathode | | Usage | Formation | and discharge | | retention |
| | Cathode active | Anode active | ratio | thickness | thickness | Formation | ratio |
| | material | material | (%) | (μm) | (μm) | method | (%) |
| Example 15-1 | LiNi_{0.79}Co_{0.14}Al_{0.07}O₂ | Si | 40 | 2 | 3 | Evaporation | 95 |
| Example 15-2 | | (containing O₂) | | 4 | 7 | method | 92 |
| Example 3-3 | | | | 7 | 12 | | 91 |
| Example 15-3 | | | | 10 | 17 | | 90 |
| Example 15-4 | | | | 17 | 27 | | 90 |
| Example 15-5 | | | | 20 | 33 | | 87 |
| Example 15-6 | | | | 25 | 40 | | 78 |
| Example 15-7 | LiNi_{0.79}Co_{0.14}Al_{0.07}O₂ | Si | 40 | 30 | 45 | Evaporation | 58 |
| | | (containing O₂) | | | | method | |

TABLE 16

| | | Anode | | | | | |
|---|---|---|---|---|---|---|---|
| | | | Anode active material layer | | | | Discharge |
| | | | | | Initial charge | | capacity |
| | Cathode | | Usage | Formation | and discharge | | retention |
| | Cathode active | Anode active | ratio | thickness | thickness | Formation | ratio |
| | material | material | (%) | (μm) | (μm) | method | (%) |
| Example 16-1 | LiCoO₂ | Si | 40 | 2 | 3 | Evaporation | 79 |
| Example 16-2 | | (containing | | 4 | 7 | method | 78 |
| Example 7-4 | | O₂) | | 7 | 12 | | 75 |
| Example 16-3 | | | | 10 | 17 | | 71 |
| Example 16-4 | | | | 17 | 27 | | 65 |
| Example 16-5 | | | | 20 | 33 | | 53 |
| Example 16-6 | | | | 25 | 40 | | 49 |
| Example 16-7 | | | | 30 | 45 | | 38 |

TABLE 17

| | | Anode | | | | | |
|---|---|---|---|---|---|---|---|
| | | | Anode active material layer | | | | Discharge |
| | | | | | Initial charge | | capacity |
| | Cathode | | Usage | Formation | and discharge | | retention |
| | Cathode active | Anode active | ratio | thickness | thickness | Formation | ratio |
| | material | material | (%) | (μm) | (μm) | method | (%) |
| Example 17-1 | LiNi_{0.79}Co_{0.14}Al_{0.07}O₂ | Si | 40 | 2 | 3 | Spraying | 95 |
| Example 17-2 | | (containing | | 4 | 5 | method | 95 |
| Example 14-3 | | O₂) | | 7 | 9 | | 94 |
| Example 17-3 | | | | 12 | 15 | | 92 |
| Example 17-4 | | | | 20 | 23 | | 89 |
| Example 17-5 | | | | 31 | 35 | | 82 |
| Example 17-6 | LiNi_{0.79}Co_{0.14}Al_{0.07}O₂ | Si | 40 | 42 | 49 | Spraying | 55 |
| | | (containing | | | | method | |
| | | O₂) | | | | | |

TABLE 18

| | | Anode | | | | | |
|---|---|---|---|---|---|---|---|
| | | | Anode active material layer | | | | Discharge |
| | | | | | Initial charge | | capacity |
| | Cathode | | Usage | Formation | and discharge | | retention |
| | Cathode active | Anode active | ratio | thickness | thickness | Formation | ratio |
| | material | material | (%) | (μm) | (μm) | method | (%) |
| Example 18-1 | LiCoO₂ | Si | 40 | 2 | 3 | Spraying | 79 |
| Example 18-2 | | (containing | | 4 | 5 | method | 74 |
| Example 18-3 | | O₂) | | 7 | 9 | | 69 |
| Example 18-4 | | | | 12 | 15 | | 60 |
| Example 18-5 | | | | 20 | 23 | | 44 |
| Example 18-6 | | | | 31 | 35 | | 39 |
| Example 18-7 | | | | 42 | 49 | | 31 |

As illustrated in Table 15 to Table 18 and FIG. 17 to FIG. 18, in the case where the cathode active material layer 21B contained the lithium-nickel based composite oxide as a cathode active material and the initial charge and discharge thickness of the anode active material layer 22B was 40 μm or less, favorable results were obtained compared to the case that these conditions were not satisfied active material layer 22B, and the formation thickness and the initial charge and discharge thickness thereof were changed as illustrated in Table 18.

More specifically, in Examples 15-1 to 15-7 in which the lithium-nickel based composite oxide (LiNi_{0.79}CO_{0.14}Al_{0.07}O₂) was used, the discharge capacity retention ratio was higher compared to in Examples 16-1 to 16-7 in which the composite oxide not applicable thereto (LiCoO₂) was used.

Further, in Examples 15-1 to 15-7 using evaporation method as a formation method of the anode active material layer 22B, in the case where the initial charge and discharge thickness was 40 μm or less, the discharge capacity retention ratio was higher compared to the case that the initial charge and discharge thickness was out of the foregoing range.

In this case, as evidenced by FIG. 17, in Examples 15-1 to 15-7, there was a tendency that in the case where the initial charge and discharge thickness was 40 μm or less, a high discharge capacity retention ratio was retained; while in the case where the initial charge and discharge thickness exceeded 40 μm, the discharge capacity retention ratio was extremely lowered. Meanwhile, in Examples 16-1 to 16-7, there was a tendency that the discharge capacity retention ratio was lowered without relation to the initial charge and discharge thickness.

The foregoing tendencies of Examples 15-1 to 15-7 and 16-1 to 16-7 were similar to those of Examples 17-1 to 17-6 and 18-1 to 18-7 using spraying method as a formation method of the anode active material layer 22B. It is needless to say that the foregoing tendencies in FIG. 17 were also shown in FIG. 18.

Accordingly, in the secondary battery of the invention, in the case where the initial charge and discharge thickness of the anode active material layer 22B was 40 μm or less, the cycle characteristics were improved.

### Examples 19-1 to 19-5, 20-1 to 20-5, and 21-1 to 21-5

A procedure similar to that of Examples 3-5, 13-5, and 14-5 was executed, except that the composition of the electrolytic solution was changed as illustrated in Table 19 to Table 21. In this case, as a solvent, 4-fluoro-1,3-dioxolane-2-one (FEC) or 4,5-difluoro-1,3-dioxolane-2-one (DFEC) that is a cyclic ester carbonate having halogen as an element was used. Further, as other solvent, 1,3-propene sultone (PRS) that is sultone or sulfobenzoic anhydride (SBAH) that is an acid anhydride was used. Further, as an electrolyte salt, lithium tetrafluoroborate (LiBF₄) was used. Further, in the case where PRS or the like was used, the content thereof in the whole solvent was 1 wt %. In the case of using LiBF₄, the content of LiPF₆ to the solvent was 0.8 mol/kg, and the content of LiBF₄ to the solvent was 0.2 mol/kg.

For the secondary batteries of Examples 19-1 to 19-5 to Examples 21-1 to 21-5, the cycle characteristics were examined. The results illustrated in Table 19 to Table 21 were obtained.

Table 19

[symbol]

Cathode active material: LiNi_{0.79}Co_{0.14}Al_{0.07}O₂; anode active material: Si (containing O₂);

formation method of anode active material layer: evaporation method; usage ratio of anode: 60%;

formation thickness of anode active material layer: 7 μm; and initial charge and discharge thickness: 12 μm

TABLE 20

| | Electrolytic solution | | | | | | | | Discharge |
|---|---|---|---|---|---|---|---|---|---|
| | | | | | | | Other | | capacity retention |
| | Solvent (volume ratio) | | | | | | solvent | Electrolyte salt | ratio |
| | EC | PC | DEC | VC | FEC | DFEC | (wt %) | (mol/kg) | (%) |
| Example 3-5 | 20 | 10 | 65 | 5 | — | — | — | LiPF₆: 1 | 85 |
| Example 19-1 | 10 | 10 | 65 | 5 | 10 | — | — | | 87 |
| Example 19-2 | 10 | 10 | 65 | 5 | — | 10 | — | | 89 |
| Example 19-3 | | | | | | | — | LiPF₆: 0.8 + | 91 |
| Example 19-4 | | | | | | | PRS: 1 | LiBF₄: 0.2 | 92 |
| Example 19-5 | | | | | | | SBAH: 1 | | 93 |

Cathode active material: LiNi_{0.79}Cu_{0.14}Al_{0.02}O₂; anode active material: Si (containing O₂);

formation method of anode active material layer: coating method (anode binder:PI); usage ratio of anode: 60%;

formation thickness of anode active material layer: 7 μm; and initial charge and discharge thickness: 12 μm

TABLE 21

| | Electrolytic solution | | | | | | | | Discharge |
|---|---|---|---|---|---|---|---|---|---|
| | | | | | | | Other | | capacity retention |
| | Solvent (volume ratio) | | | | | | solvent | Electrolyte salt | ratio |
| | EC | PC | DEC | VC | FEC | DFEC | (wt %) | (mol/kg) | (%) |
| Example 13-5 | 20 | 10 | 65 | 5 | — | — | — | LiPF₆: 1 | 77 |
| Example 20-1 | 10 | 10 | 65 | 5 | 10 | — | — | | 80 |
| Example 20-2 | 10 | 10 | 65 | 5 | — | 10 | — | | 81 |
| Example 20-3 | | | | | | | — | LiPF₆: 0.8 + | 83 |
| Example 20-4 | | | | | | | PRS: 1 | LiBF₄: 0.2 | 85 |
| Example 20-5 | | | | | | | SBAH: 1 | | 85 |

Cathode active material: LiNi_{0.79}Cu_{0.14}Al_{0.07}O₂; anode active material: Si (containing O₂);

formation method of anode active material layer: spraying method; usage ratio of anode: 60%;

formation thickness of anode active material layer: 7 μm; and initial charge and discharge thickness: 9 μm

TABLE 21

| | Electrolytic solution | | | | | | | | Discharge |
|---|---|---|---|---|---|---|---|---|---|
| | | | | | | | Other | | capacity retention |
| | Solvent (volume ratio) | | | | | | solvent | Electrolyte salt | ratio |
| | EC | PC | DEC | VC | FEC | DFEC | (wt %) | (mol/kg) | (%) |
| Example 14-5 | 20 | 10 | 65 | 5 | — | — | — | LiPF₆: 1 | 89 |
| Example 21-1 | 10 | 10 | 65 | 5 | 10 | — | — | | 90 |
| Example 21-2 | 10 | 10 | 65 | 5 | — | 10 | — | | 92 |
| Example 21-3 | | | | | | | — | LiPF₆: 0.8 + | 93 |
| Example 21-4 | | | | | | | PRS: 1 | LiBF₄: 0.2 | 94 |
| Example 21-5 | | | | | | | SBAH: 1 | | 96 |

As illustrated in Table 18 to Table 21, in Examples 19-1 to 19-5 and the like in which FEC or LiBF₄ or the like was added to the electrolytic solution, the discharge capacity retention ratio was higher compared to in Example 3-5 or the like in which FEC or LiBF₄ or the like was not added.

Accordingly, in the secondary battery of the invention, in the case where FEC or the like was added as a solvent to the electrolytic solution, or LiBF₄ was added as an electrolyte salt, the cycle characteristics were more improved.

### Examples 22-1 to 22-4

A procedure similar to that of Example 3-5 was executed, except that the structure of the separator 23 was changed as illustrated in Table 22. The respective separators 23 had a three layer structure, and their detailed structures were as follows: polypropylene film (thickness: 2.5 μm)/polyethylene film (thickness: 18 μm)/polypropylene film (thickness: 2.5 μm); PVDF layer (thickness: 2 μm)/polyethylene film (thickness: 18 μm)/PVDF layer (thickness: 2 μm); aramid resin layer (thickness: 2 μm)/polyethylene film (thickness: 18 μm)/aramid resin layer (thickness: 2 μm); and aramid resin layer containing insulating particles (silicon oxide) (thickness: 2 μm)/polyethylene film (thickness: 18 μm)/aramid resin layer containing insulating particles (silicon oxide) (thickness: 2.5 μm). The median diameter of the insulating particles was 0.1 μm, and the content of the insulating particles in the aramid resin layer was 5 wt %.

For the secondary batteries of Examples 22-1 to 22-4, the cycle characteristics were examined. The results illustrated in Table 22 were obtained.

Table 22

[symbol]

Cathode active material: LiNi_{0.79}Cu_{0.14}Al_{0.07}O₂; anode active material: Si (containing O₂);

formation method of anode active material layer: evaporation method; usage ratio of anode: 60%;

formation thickness of anode active material layer: 7 μm; and initial charge and discharge thickness: 12 μm

| | | Discharge capacity |
|---|---|---|
| | Separator | retention ratio (%) |
| Example 3-5 | PE | 85 |
| Example 22-1 | PP/PE/PP | 88 |
| Example 22-2 | PVDF/PE/PVDF | 90 |
| Example 22-3 | Aramid/PE/aramid | 87 |
| Example 22-4 | Aramid (SiO₂)/PE/aramid (SiO₂) | 90 |

As illustrated in Table 22, in Examples 22-1 to 22-4 in which the separator 23 having a three layer structure was used, the discharge capacity retention ratio was higher compared to in Example 3-5 in which the separator 23 having a single layer structure was used.

Accordingly, in the secondary battery of the invention, in the case where the separator 23 having a three layer structure was used, the cycle characteristics were more improved.

### Examples 23-1 to 23-6, 24-1 to 24-6, 25-1 to 25-6, and 26-1 to 26-6

A procedure similar to that of Examples 3-3, 7-4, 3-5, and 7-6 was executed, except that the upper voltage in charge in the cycle test was changed as illustrated in Table 23 to Table 26.

Table 23

[symbol]

Cathode active material: LiNi_{0.79}Cu_{0.14}Al_{0.07}O₂; anode active material: Si (containing O₂);

formation method of anode active material layer: evaporation method; usage ratio of anode: 40%;

formation thickness of anode active material layer: 7 μm; and initial charge and discharge thickness: 12 μm

TABLE 24

| | Upper voltage | Cutoff voltage | Discharge capacity |
|---|---|---|---|
| | (V) | (V) | retention ratio (%) |
| Example 23-1 | 4.23 | 2.7 | 90 |
| Example 3-3 | 4.20 | | 91 |
| Example 23-2 | 4.18 | | 93 |
| Example 23-3 | 4.15 | | 94 |
| Example 23-4 | 4.10 | | 95 |
| Example 23-5 | 4.05 | | 95 |
| Example 23-6 | 3.95 | | 95 |

Cathode active material: LiCoO₂; anode active material: Si (containing O₂);

formation method of anode active material layer: evaporation method; usage ratio of anode: 40%;

formation thickness of anode active material layer: 7 μm; and initial charge and discharge thickness: 12 μm

TABLE 25

| | Upper voltage | Cutoff voltage | Discharge capacity |
|---|---|---|---|
| | (V) | (V) | retention ratio (%) |
| Example 24-1 | 4.23 | 2.7 | 75 |
| Example 7-4 | 4.20 | | 75 |
| Example 24-2 | 4.18 | | 77 |
| Example 24-3 | 4.15 | | 78 |
| Example 24-4 | 4.10 | | 80 |
| Example 24-5 | 4.05 | | 83 |
| Example 24-6 | 3.95 | | 85 |

Cathode active material: LiNi_{0.79}Cu_{0.14}Al_{0.07}O₂; anode active material: Si (containing O₂);

formation method of anode active material layer: evaporation method; usage ratio of anode: 60%;

formation thickness of anode active material layer: 7 μm; and initial charge and discharge thickness: 12 μm

TABLE 26

| | Upper voltage | Cutoff voltage | Discharge capacity |
|---|---|---|---|
| | (V) | (V) | retention ratio (%) |
| Example 25-1 | 4.23 | 2.7 | 85 |
| Example 3-5 | 4.20 | | 85 |
| Example 25-2 | 4.18 | | 87 |
| Example 25-3 | 4.15 | | 88 |
| Example 25-4 | 4.10 | | 89 |
| Example 25-5 | 4.05 | | 89 |
| Example 25-6 | 3.95 | | 90 |

Cathode active material: LiCoO₂; anode active material: Si (containing O₂);

formation method of anode active material layer: evaporation method; usage ratio of anode: 60%;

formation thickness of anode active material layer: 7 μm; and initial charge and discharge thickness: 12 μm

| | Upper voltage | Cutoff voltage | Discharge capacity |
|---|---|---|---|
| | (V) | (V) | retention ratio (%) |
| Example 26-1 | 4.23 | 2.7 | 66 |
| Example 7-6 | 4.20 | | 67 |
| Example 26-2 | 4.18 | | 70 |
| Example 26-3 | 4.15 | | 72 |
| Example 26-4 | 4.10 | | 75 |
| Example 26-5 | 4.05 | | 77 |
| Example 26-6 | 3.05 | | 79 |

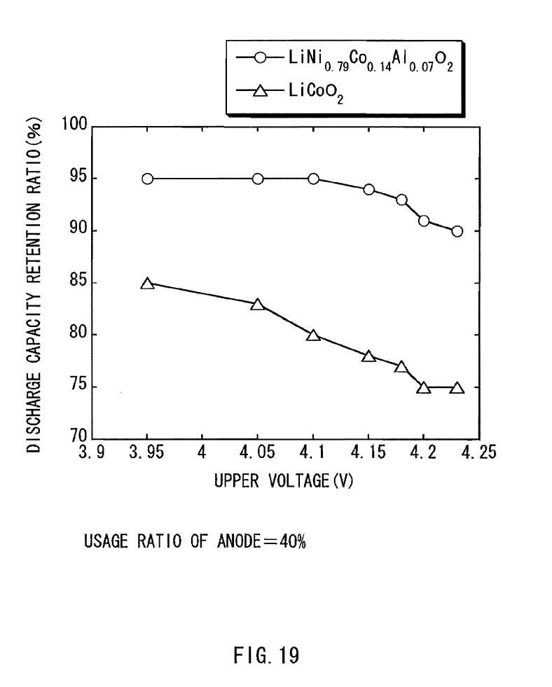

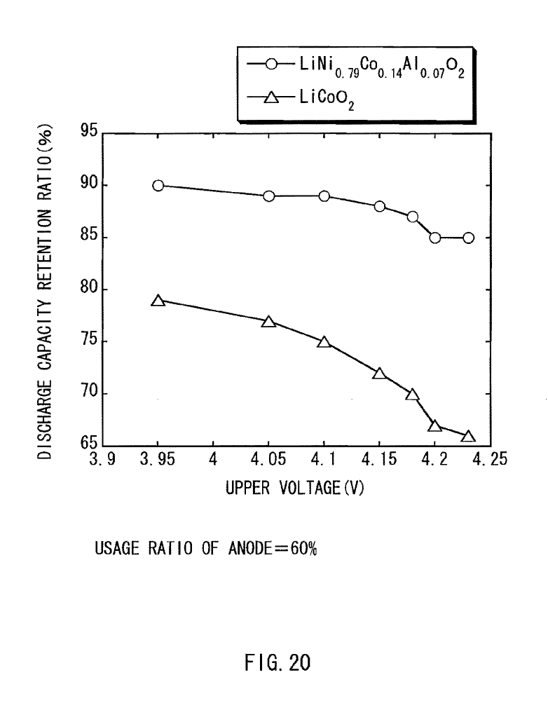

As illustrated in Table 23 to Table 26 and FIG. 19 to FIG. 20, in the case where the cathode active material layer 21B contained the lithium-nickel based composite oxide as a cathode active material and the upper voltage was 4.18 V or less, favorable results were obtained compared to the case that these conditions were not satisfied.

More specifically, in Examples 23-1 to 23-6 and 25-1 to 25-6 in which LiNi_{0.79}Cu_{0.14}Al_{0.07}O₂ as a lithium-nickel based composite oxide was used, the discharge capacity retention ratio was higher compared to in Examples 24-1 to 24-6 and 26-1 to 26-6 in which LiCoO₂ as a composite oxide not applicable thereto was used.

Further, in Examples 23-1 to 23-6 and 25-1 to 25-6 in which LiNi_{0.79}Cu_{0.14}Al_{0.07}O₂ was used, in the case where the upper voltage was 4.18 V or less, the discharge capacity retention ratio was higher compared to the case that the upper voltage exceeded 4.18 V.

Accordingly, in the secondary battery of the invention, in the case where the upper voltage in charge was 4.18 V or less, the cycle characteristics were more improved.

### Examples 27-1 to 27-6, 28-1 to 28-6, 29-1 to 29-6, and 30-1 to 30-6

A procedure similar to that of Examples 3-3, 7-4, 3-5, and 7-6 was executed, except that the cutoff voltage in discharge in the cycle test was changed as illustrated in Table 27 to Table 30.

Table 27

[symbol]

Cathode active material: LiNi_{0.79}Cu_{0.14}Al_{0.07}O₂; anode active material: Si (containing O₂);

formation method of anode active material layer: evaporation method; usage ratio of anode: 40%;

formation thickness of anode active material layer: 7 μm; and initial charge and discharge thickness: 12 μm

TABLE 28

| | Upper voltage | Cutoff voltage | Discharge capacity |
|---|---|---|---|
| | (V) | (V) | retention ratio (%) |
| Example 27-1 | 4.20 | 3.3 | 82 |
| Example 27-2 | | 3.0 | 87 |
| Example 3-3 | | 2.7 | 91 |
| Example 27-3 | | 2.5 | 93 |
| Example 27-4 | | 2.3 | 90 |
| Example 27-5 | | 2.0 | 86 |
| Example 27-6 | | 1.8 | 80 |

Cathode active material: LiCoO₂; anode active material: Si (containing O₂);

formation method of anode active material layer: evaporation method; usage ratio of anode: 40%;

formation thickness of anode active material layer: 7 μm; and initial charge and discharge thickness: 12 μm

TABLE 29

| | Upper voltage | Cutoff voltage | Discharge capacity |
|---|---|---|---|
| | (V) | (V) | retention ratio (%) |
| Example 28-1 | 4.20 | 3.3 | 83 |
| Example 28-2 | | 3.0 | 79 |
| Example 7-4 | | 2.7 | 75 |
| Example 28-3 | | 2.5 | 73 |
| Example 28-4 | | 2.3 | 71 |
| Example 28-5 | | 2.0 | 68 |
| Example 28-6 | | 1.8 | 69 |

Cathode active material: LiNi_{0.79}Co_{0.14}Al_{0.07}O₂; anode active material: Si (containing O₂);

formation method of anode active material layer: evaporation method; usage ratio of anode: 60%;

formation thickness of anode active material layer: 7 μm; and initial charge and discharge thickness: 12 μm

TABLE 30

| | Upper voltage | Cutoff voltage | Discharge capacity |
|---|---|---|---|
| | (V) | (V) | retention ratio (%) |
| Example 29-1 | 4.20 | 3.3 | 78 |
| Example 29-2 | | 3.0 | 82 |
| Example 3-5 | | 2.7 | 85 |
| Example 29-3 | | 2.5 | 86 |
| Example 29-4 | | 2.3 | 83 |
| Example 29-5 | | 2.0 | 82 |
| Example 29-6 | | 1.8 | 77 |

Cathode active material: LiCoO₂; anode active material: Si (containing O₂);

formation method of anode active material layer: evaporation method; usage ratio of anode: 60%;

formation thickness of anode active material layer: 7 μm; and initial charge and discharge thickness: 12 μm

| | Upper voltage | Cutoff voltage | Discharge capacity |
|---|---|---|---|
| | (V) | (V) | retention ratio (%) |
| Example 30-1 | 4.20 | 3.3 | 73 |
| Example 30-2 | | 3.0 | 70 |
| Example 7-6 | | 2.7 | 67 |
| Example 30-3 | | 2.5 | 64 |
| Example 30-4 | | 2.3 | 62 |
| Example 30-5 | | 2.0 | 60 |
| Example 30-6 | | 1.8 | 56 |

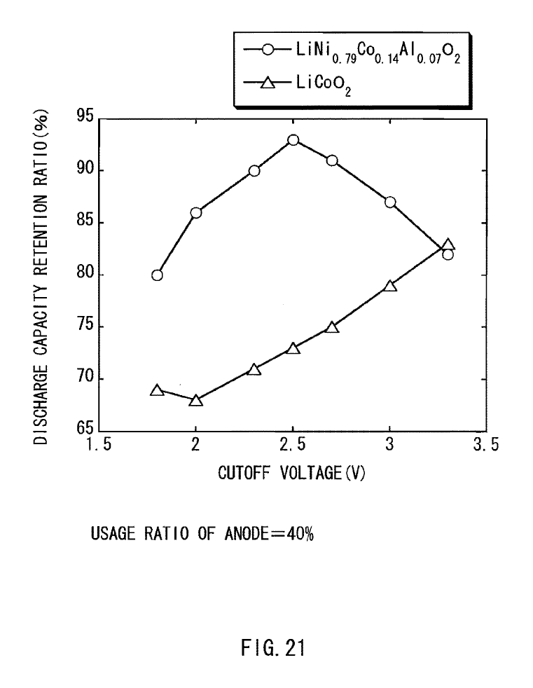

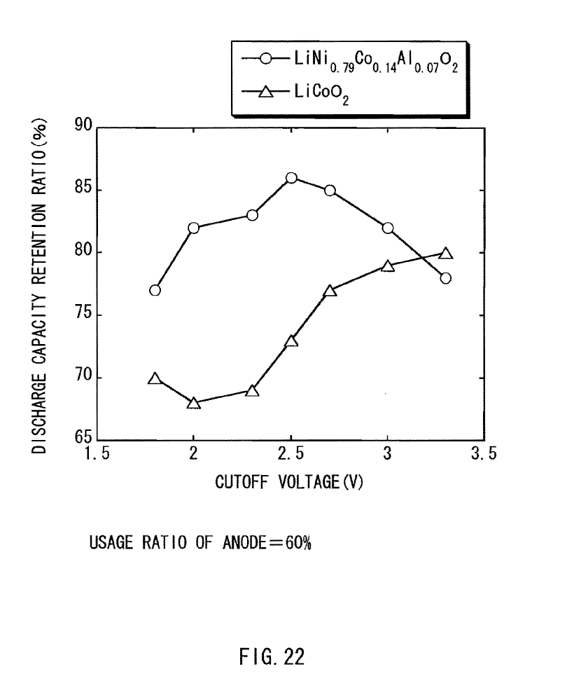

As illustrated in Table 27 to Table 30 and FIG. 21 to FIG. 22, in the case where the cathode active material layer 21B contained the lithium-nickel based composite oxide as a cathode active material and the cutoff voltage was 3.0 V or less, favorable results were obtained compared to the case that these conditions were not satisfied.

More specifically, in Examples 27-1 to 27-6 and 29-1 to 29-6 in which LiNi_{0.79}Co_{0.14}Al_{0.07}O₂ as a lithium-nickel based composite oxide was used, the discharge capacity retention ratio was higher compared to in Examples 28-1 to 28-6 and 30-1 to 30-6 in which LiCoO₂ as a composite oxide not applicable thereto was used.

Further, in Examples 27-1 to 27-6 and 29-1 to 29-6 in which LiNi_{0.79}Cu_{0.14}Al_{0.07}O₂ was used, in the case where the cutoff voltage was 3.0 V or less, the discharge capacity retention ratio was higher compared to the case that the cutoff voltage exceeded 3.0 V.

Accordingly, in the secondary battery of the invention, in the case where the cutoff voltage in discharge was 3.0 V or less, the cycle characteristics were more improved.

As evidenced by the results of the foregoing Table 1 to Table 30 and FIG. 9 to FIG. 22, in the secondary battery of the invention, by satisfying the following four conditions A to D, the cycle characteristics, the initial charge and discharge characteristics, and the swollenness characteristics are able to be improved not depending on the formation method of the anode active material layer, the structure of the separator, the composition of the electrolytic solution and the like:

A. The cathode active material layer of the cathode contains the cathode active material being capable of inserting and extracting an electrode reactant and being expressed by Formula 1.

B. The anode active material layer of the anode contains the anode active material being capable of inserting and extracting an electrode reactant and having silicon as an element.

C. The usage ratio in a fully charged state of the anode is from 20% to 70% both inclusive.

D. The thickness of the anode active material layer in a discharged state in the initial charge and discharge is 40 μm or less.

The invention has been described with reference to the several embodiments and the examples. However, the invention is not limited to the aspects described in the foregoing embodiments and the foregoing examples, and various modifications may be made. For example, in the foregoing respective embodiments and the foregoing examples, the descriptions have been given of the secondary battery in which the anode capacity is expressed based on inserting and extracting an electrode reactant as a secondary battery type. However, the secondary battery of the invention is not limited thereto. The invention is able to be similarly applied to a secondary battery in which the anode capacity includes the capacity based on inserting and extracting the electrode reactant and the capacity based on precipitation and dissolution of the electrode reactant, and the anode capacity is expressed as the sum of these capacities. In such a secondary battery, an anode material capable of inserting and extracting the electrode reactant is used as an anode active material, and the chargeable capacity of the anode material is set to a smaller value than that of the discharge capacity of the cathode.

Further, in the foregoing respective embodiments and the foregoing examples, the description has been given with the specific examples that the battery structure is the square type, the cylindrical type, or the laminated film type, and with the specific example of the case that the battery element has the spirally wound structure. However, the invention is not necessarily limited thereto, and is able to be similarly applied to a case having other battery structure such as a coin type or a button type, or a case that the battery element has other structure such as a laminated structure.

Further, in the foregoing respective embodiments and the foregoing examples, the description has been given of the case using lithium ions as an electrode reactant. However, as an electrode reactant, other Group 1 element such as sodium (Na) or potassium (K), a Group 2A element such as magnesium (Mg) or calcium (Ca), or other light metal ions such as aluminum ions may be used, since the effects of the invention should be obtained not depending on the electrode reactant type. In the case where the electrode reactant type is changed, similar effects are able to be obtained.

Further, in the foregoing respective embodiments and the foregoing examples, regarding the thickness of the anode active material layer in a discharged state in the initial charge and discharge for the secondary battery of the invention, the numerical value range thereof derived from the results of the examples has been described. However, such a description does not totally eliminate the possibility that the thickness may be out of the foregoing range. That is, the foregoing appropriate range is the range particularly preferable for obtaining the effects of the invention. Therefore, as long as effects of the invention are obtained, the thickness may be out of the foregoing range in some degrees. The same is applied to the usage ratio of the anode.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
a cathode having a cathode active material layer on a cathode current collector;
an anode having an anode active material layer on an anode current collector; and
an electrolyte containing a solvent and an electrolyte salt,
wherein the cathode active material layer contains a cathode active material being capable of inserting and extracting an electrode reactant and being expressed by Formula 1,
the anode active material layer contains an anode active material being capable of inserting and extracting the electrode reactant and having silicon (Si) as an element,
a usage ratio in a fully charged state of the anode is from 20% to 70% both inclusive, and
a thickness of the anode active material layer in a discharged state in an initial charge and discharge is 40 μm or less.
Formula 1
LiNi₁₋ₓMₓO₂ (1)
where M is one or more of cobalt (Co), manganese (Mn), iron (Fe), aluminum (Al), vanadium (V), tin (Sn), magnesium (Mg), titanium (Ti), strontium (Sr), calcium (Ca), zirconium (Zr), molybdenum (Mo), technetium (Tc), ruthenium (Ru), tantalum (Ta), tungsten (W), rhenium (Re), ytterbium (Yb), copper (Cu), zinc (Zn), barium (Ba), boron (B), chromium (Cr), silicon, gallium (Ga), phosphorus (P), antimony (Sb), and niobium (Nb). x is in the range of 0.005<x<0.5.

2. The secondary battery according to claim 1, wherein the thickness of the anode active material layer in the discharged state in the initial charge and discharge is 3 μM or more.

3. The secondary battery according to claim 1, wherein the cathode active material is a lithium nickel cobalt composite oxide (LiNi₁₋ₓCOₓO₂), a lithium nickel cobalt manganese composite oxide (LiNi₁₋ₓ(CoMn)ₓ(O₂), a lithium nickel cobalt aluminum composite oxide (LiNi₁₋ₓ(CoAl)ₓO₂), a lithium nickel cobalt aluminum barium composite oxide (LiNi₁₋ₓ(CoAlBa)ₓO₂), or a lithium nickel cobalt aluminum iron composite oxide (LiNi₁₋ₓ(CoAlFe)ₓO₂).

4. The secondary battery according to claim 3, wherein the cathode active material is lithium nickel cobalt composite oxide (LiNi_{0.80}CO_{0.20}O₂), lithium nickel cobalt manganese composite oxide (LiNi_{0.80}Co_{0.10}Mn_{0.10}O₂), lithium nickel cobalt aluminum composite oxide (LiNi_{0.79}CO_{0.14}Al_{0.07}O₂), lithium nickel cobalt aluminum barium composite oxide (LiNi_{0.76}Co_{0.20}Al_{0.03}Ba_{0.01}O₂), or lithium nickel cobalt aluminum iron composite oxide (LiNi_{0.80}Co_{0.10}Al_{0.06}Fe_{0.04}O₂).

5. The secondary battery according to claim 1, wherein the anode active material is one or more of a simple substance, an alloy, and a compound of silicon.

6. The secondary battery according to claim 5, wherein the anode active material is the simple substance of silicon.

7. The secondary battery according to claim 1, wherein the anode active material has oxygen (O) as an element.

8. The secondary battery according to claim 1, wherein the anode active material has a high oxygen-containing region having a relatively high oxygen content and a low oxygen-containing region having a relatively low oxygen content in a thickness direction.

9. The secondary battery according to claim 1, wherein the anode current collector and the anode active material layer are alloyed in at least part of the interface thereof.

10. The secondary battery according to claim 1, wherein the anode active material is arranged on the anode current collector, and is in a state of a plurality of particles linked to a surface thereof.

11. The secondary battery according to claim 10, wherein the anode active material layer contains a metal material not being alloyed with the electrode reactant in a gap therein, and the metal material has one or more of nickel, cobalt, and iron as an element.

12. The secondary battery according to claim 1 comprising:
a separator to separate the cathode from the anode, wherein the separator contains a porous film made of polyethylene or polypropylene.

13. The secondary battery according to claim 12, wherein the separator has a polymer compound layer different from the porous film on the porous film.

14. The secondary battery according to claim 13, wherein the polymer compound layer contains insulating particles.

15. The secondary battery according to claim 1, wherein the solvent contains one or more of cyclic ester carbonates having an unsaturated carbon bond shown in Formula 2 to Formula 4, a chain ester carbonate having halogen as an element shown in Formula 5, a cyclic ester carbonate having halogen as an element shown in Formula 6, sultone, and an acid anhydride. 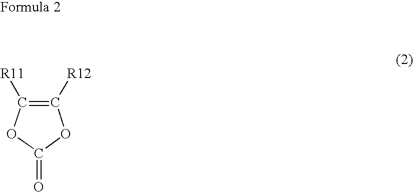
where R11 and R12 are a hydrogen group or an alkyl group. 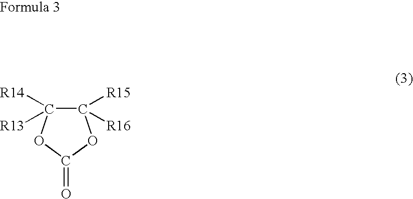
where R13 to R16 are a hydrogen group, an alkyl group, a vinyl group, or an aryl group. One or more of R13 to R16 is the vinyl group or the aryl group. 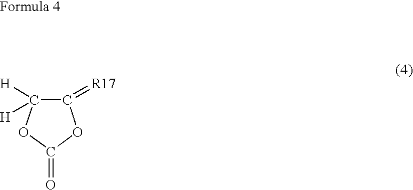
where R17 is an alkylene group. 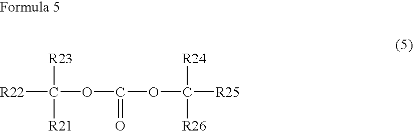
where R21 to R26 are a hydrogen group, a halogen group, an alkyl group, or an alkyl halide group. One or more of R21 to R26 is the halogen group or the alkyl halide group. 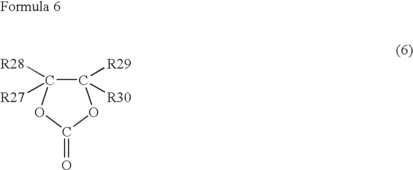
where R27 to R30 are a hydrogen group, a halogen group, an alkyl group, or an alkyl halide group. One or more of R27 to R30 is the halogen group or the alkyl halide group.

16. The secondary battery according to claim 1, wherein the electrolyte salt contains one or more of lithium hexafluorophosphate (LiPF₆), lithium tetrafluoroborate (LiBF₄), lithium perchlorate (LiClO₄), lithium hexafluoroarsenate (LiAsF₆), and compounds shown in Formula 7 to Formula 12. 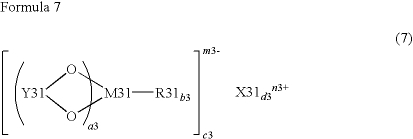
where X31 is a Group 1 element or a Group 2 element in the long period periodic table or aluminum (Al). M31 is a transition metal element, a Group 13 element, a Group 14 element, or a Group 15 element in the long period periodic table. R31 is a halogen group. Y31 is —(O═)C—R32-C(═O)—, —(O═)C—C(R33)₂-, or —(O═)C—C(═O)—. R32 is an alkylene group, an alkylene halide group, an arylene group, or an arylene halide group. R33 is an alkyl group, an alkyl halide group, an aryl group, or an aryl halide group. a3 is one of integer numbers 1 to 4. b3 is 0, 2, or 4. c3, d3, m3, and n3 are one of integer numbers 1 to 3. 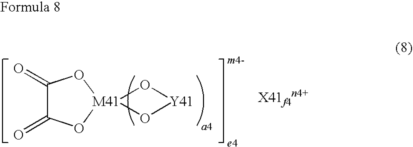
where X41 is a Group 1 element or a Group 2 element in the long period periodic table. M41 is a transition metal element, a Group 13 element, a Group 14 element, or a Group 15 element in the long period periodic table. Y41 is —(O═)C—(C(R41)₂)_{b4}-C(═O)—, —(R43)₂C—(C(R42)₂)_{c4}-C(R43)₂-, —(R43)₂C—(C(R42)₂)_{c4}-S(═O)₂—, —(O═)₂S—(C(R42)₂)_{d4}-S(═O)₂—, or —(O═)C—(C(R42)₂)_{d4}-S(═O)₂—. R41 and R43 are a hydrogen group, an alkyl group, a halogen group, or an alkyl halide group. One or both of R41 and R43 is respectively the halogen group or the alkyl halide group. R42 is a hydrogen group, an alkyl group, a halogen group, or an alkyl halide group. a4, e4, and n4 are an integer number of 1 or 2. b4 and d4 are one of integer numbers 1 to 4. c4 is one of integer numbers 0 to 4. f4 and m4 are one of integer numbers 1 to 3. 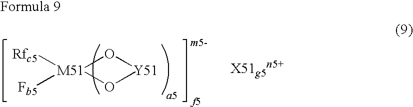
where X51 is a Group 1 element or a Group 2 element in the long period periodic table. M51 is a transition metal element, a Group 13 element, a Group 14 element, or a Group 15 element in the long period periodic table. Rf is a fluorinated alkyl group with the carbon number of from 1 to 10 both inclusive or a fluorinated aryl group with the carbon number of from 1 to 10 both inclusive. Y51 is —(O═)C—(C(R51)₂)_{d5}-C(═O)—, —(R52)₂C—(C(R51)₂)_{d5}-C(═O)—, —(R52)₂C—(C(R51)₂)_{d5}-C(R52)₂-, —(R52)₂C—(C(R51)₂)_{d5}-S(═O)₂—, —(O═)₂S—(C(R51)₂)ₑ₅-S(═O)₂—, or —(O═)C—(C(R51)₂)ₑ₅-S(═O)₂—. R51 is a hydrogen group, an alkyl group, a halogen group, or an alkyl halide group. R52 is a hydrogen group, an alkyl group, a halogen group, or an alkyl halide group, and one or more thereof is the halogen group or the alkyl halide group. a5, f5, and n5 are 1 or 2. b5, c5, and e5 are one of integer numbers 1 to 4. d5 is one of integer numbers 0 to 4. g5 and m5 are one of integer numbers 1 to 3.
Formula 10
LiN(CₘF₂ₘ₊₁SO₂)(CₙF₂ₙ₊₁SO₂) (10)
where m and n are an integer number of 1 or more. 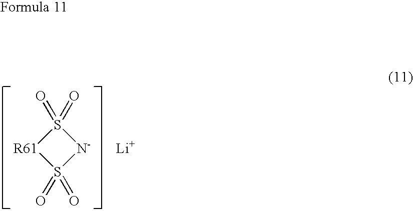
where R61 is a straight chain/branched perfluoro alkylene group with the carbon number of from 2 to 4 both inclusive.
Formula 12
LiC(CₚF₂ₚ₊₁SO₂)(C_{q}F_{2q+1}SO₂)(CᵣF₂ᵣ₊₁SO₂) (12)
where p, q, and r are an integer number of 1 or more.

17. The secondary battery according to claim 1, wherein the electrode reactant is lithium ions.

18. The secondary battery according to claim 1, wherein an upper voltage in charge is 4.18 V or less.

19. The secondary battery according to claim 1, wherein a cutoff voltage in discharge is 3.0 V or less.
